(19) United States
(12) Patent Application Publication
(10) Pub. No.: US 2025/0323747 A1
(43) Pub. Date: Oct. 16, 2025

(54) Multi-Chip Optical Data Communication Systems Implementing Common Remote Optical Power Supply

(71) Applicant: Ayar Labs, Inc., San Jose, CA (US)

(72) Inventors: Manan Raval, Oakland, CA (US); Matthew Sysak, Sunnyvale, CA (US); Mark Wade, Berkeley, CA (US); Chen Sun, Berkeley, CA (US)

(21) Appl. No.: 19/174,757

(22) Filed: Apr. 9, 2025

Related U.S. Application Data
(60) Provisional application No. 63/633,599, filed on Apr. 12, 2024.

(51) Int. Cl. H04J 14/02

(52) U.S. Cl. CPC H04J 14/02

(57) ABSTRACT

An optical data communication system includes an optical power supply and a plurality of electro-optical chips that exists separate and remote from the optical power supply. The optical power supply includes a plurality of lasers, each of which is configured to generate and output a beam of continuous wave light of a different one of a plurality of wavelengths. The optical power supply has a plurality of optical outputs, and is configured to convey all of the plurality of wavelengths of continuous wave light through each of the plurality of optical outputs. Each of the plurality of electro-optical chips has multiple optical inputs respectively optically connected to optical outputs within a corresponding portion of the plurality of optical outputs of the optical power supply. Also, each of the plurality of electro-optical chips is optically connected to a different portion of the plurality of optical outputs of the optical power supply.

### CROSS-REFERENCE TO RELATED APPLICATIONS

This application claims priority under 35 U.S.C. 119(e) to U.S. Provisional Patent Application No. 63/633,599, filed on Apr. 12, 2024, the disclosure of which is incorporated herein by reference in its entirety for all purposes.

### BACKGROUND OF THE INVENTION

### 1. Field of the Invention

The disclosed embodiments relate to optical data communication.

### 2. Description of the Related Art

Optical data communication systems operate by modulating laser light to encode digital data patterns. The modulated laser light is transmitted through an optical data network from a sending node to a receiving node. The modulated laser light having arrived at the receiving node is de-modulated to obtain the original digital data patterns. Therefore, implementation and operation of optical data communication systems is dependent upon having reliable and efficient laser light sources. Also, it is desirable for the laser light sources of optical data communication systems to have a minimal form factor and be designed as efficiently as possible with regard to expense and energy consumption. It is within this context that the present disclosed embodiments arise.

### SUMMARY OF THE INVENTION

In an example embodiment, an optical data communication system is disclosed. The optical data communication system includes an optical power supply and a plurality of electro-optical chips that exists separate and remote from the optical power supply. The optical power supply includes a plurality of lasers. Each of the plurality of lasers is configured to generate and output a beam of continuous wave light of a different one of a plurality of wavelengths. The optical power supply has a plurality of optical outputs. The optical power supply is configured to convey all of the plurality of wavelengths of continuous wave light through each of the plurality of optical outputs. Each electro-optical chip of the plurality of electro-optical chips has multiple optical inputs respectively optically connected to optical outputs within a corresponding portion of the plurality of optical outputs of the optical power supply. Each electro-optical chip of the plurality of electro-optical chips is optically connected to a different portion of the plurality of optical outputs of the optical power supply.

In an example embodiment, an optical data communication system is disclosed. The optical data communication system includes an optical power supply, which includes a plurality of lasers. Each of the plurality of lasers is configured to generate and output a beam of continuous wave light of a different one of a plurality of wavelengths. The optical power supply has a plurality of optical outputs. The optical power supply is configured to convey a particular subset of the plurality of wavelengths of continuous wave light through each optical output within a particular subset of the plurality of optical outputs, such that each optical output within a given subset of the plurality of optical outputs receives a same subset of the plurality of wavelengths of continuous wave light, and such that different subsets of the plurality of optical outputs receive different subsets of the plurality of wavelengths of continuous wave light. The optical data communication system also includes a plurality of electro-optical chips that exists separate and remote from the optical power supply. Each electro-optical chip of the plurality of electro-optical chips has multiple optical inputs respectively optically connected to optical outputs within a corresponding subset of the plurality of optical outputs of the optical power supply. Each electro-optical chip of the plurality of electro-optical chips is optically connected to a different subset of the plurality of optical outputs of the optical power supply, such that each electro-optical chip of the plurality of electro-optical chips receives a different subset of the plurality of wavelengths of continuous wave light from the optical power supply.

In an example embodiment, an optical data communication system is disclosed. The an optical data communication system includes an optical power supply that includes a plurality of lasers. Each of the plurality of lasers is configured to generate and output a beam of continuous wave light of a different one of a plurality of wavelengths. The plurality of wavelengths are delineated into a plurality of wavelength subsets. Each one of the plurality of wavelength subsets is different and exclusive from others of the plurality of wavelength subsets. The optical power supply has a plurality of optical outputs. The optical power supply is configured to convey continuous wave light of any one wavelength subset of the plurality of wavelength subsets through a given one of the plurality of optical outputs. The plurality of optical outputs are delineated into plurality of subsets of optical outputs. Each one of the plurality of subsets of optical outputs is different and exclusive from others of the plurality of subsets of optical outputs. At least two optical outputs within each subset of optical outputs respectively receives different wavelength subsets of the plurality of wavelength subsets. The optical data communication system also includes an electro-optical chip that exists separate and remote from the optical power supply. The electro-optical chip has multiple optical inputs respectively optically connected to optical outputs within a corresponding single subset of optical outputs of the optical power supply.

In an example embodiment, an electro-optical chip is disclosed. The electro-optical chip includes a plurality of transmit macros. Each of the plurality of transmit macros includes a respective optical waveguide and a respective plurality of ring resonators positioned within an evanescent optical coupling distance of the respective optical waveguide. The electro-optical chip also includes an optical distribution network that has a number of initially active optical inputs and a number of spare optical inputs. Each of the number of initially active optical inputs is optically connected to a respective optical fiber through which continuous wave laser light is conveyed. Each of the number of spare optical inputs is optically connected to a respective optical fiber through which continuous wave laser light is conveyed. Each of the number of spare optical inputs is activatable upon failure of a corresponding one of the initially active optical inputs. The optical distribution network has a number of optical outputs. Each of the number of optical outputs is optically connected to the optical waveguide of a corresponding one of the plurality of transmit macros. A total number of the plurality of transmit macros exceeds the number of initially active optical inputs.

In an example embodiment, a method is disclosed for optical data communication. The method includes respectively optically connecting a first plurality of optical outputs of an optical power supply to a first plurality of optical inputs of a first electro-optical chip, where the first electro-optical chip exists separate and remote from the optical power supply. The method also includes respectively optically connecting a second plurality of optical outputs of the optical power supply to a second plurality of optical inputs of a second electro-optical chip, where the second electro-optical chip exists separate and remote from the optical power supply. The method also includes operating the optical power supply to generate a plurality of beams of continuous wave light that respectively have a plurality of wavelengths. The method also includes conveying all of the plurality of wavelengths of continuous wave light through each of the first plurality of optical outputs of the optical power supply and through each of the second plurality of optical outputs of the optical power supply.

In an example embodiment, a method is disclosed for optical data communication. The method includes respectively optically connecting a first plurality of optical outputs of an optical power supply to a first plurality of optical inputs of a first electro-optical chip, where the first electro-optical chip exists separate and remote from the optical power supply. The method also includes respectively optically connecting a second plurality of optical outputs of the optical power supply to a second plurality of optical inputs of a second electro-optical chip, where the second electro-optical chip exists separate and remote from the optical power supply. The method also includes operating the optical power supply to generate a first plurality of beams of continuous wave light respectively having a first plurality of wavelengths. The method also includes conveying all of the first plurality of wavelengths of continuous wave light through each of the first plurality of optical outputs of the optical power supply. The method also includes operating the optical power supply to generate a second plurality of beams of continuous wave light respectively having a second plurality of wavelengths. The method also includes conveying all of the second plurality of wavelengths of continuous wave light through each of the second plurality of optical outputs of the optical power supply.

In an example embodiment, a method is disclosed for optical data communication. The method includes respectively optically connecting a first plurality of optical outputs of an optical power supply to a first plurality of optical inputs of a first electro-optical chip, where the first electro-optical chip exists separate and remote from the optical power supply. The method also includes respectively optically connecting a second plurality of optical outputs of the optical power supply to a second plurality of optical inputs of a second electro-optical chip, where the second electro-optical chip exists separate and remote from the optical power supply. The method also includes operating the optical power supply to generate a first plurality of beams of continuous wave light respectively having a first plurality of wavelengths. The method also includes operating the optical power supply to generate a second plurality of beams of continuous wave light respectively having a second plurality of wavelengths. The method also includes conveying all of the first plurality of wavelengths of continuous wave light through at least one of the first plurality of optical outputs of the optical power supply. The method also includes conveying all of the second plurality of wavelengths of continuous wave light through at least one of the first plurality of optical outputs of the optical power supply. The method also includes conveying all of the first plurality of wavelengths of continuous wave light through at least one of the second plurality of optical outputs of the optical power supply. The method also includes conveying all of the second plurality of wavelengths of continuous wave light through at least one of the second plurality of optical outputs of the optical power supply.

Other aspects and advantages of the disclosed embodiments will become more apparent from the following detailed description, taken in conjunction with the accompanying drawings, illustrating by way of example the disclosed embodiments.

### BRIEF DESCRIPTION OF THE DRAWINGS

FIG. 1A shows an example block-level architecture of a system implementing an electro-optical chip, in accordance with some embodiments.

FIG. 1B shows a vertical cross-section diagram of the substrate of FIG. 1A, in accordance with some embodiments.

FIG. 2 shows an example organizational diagram of the electro-optical chip referenced herein, in accordance with some embodiments.

FIG. 3 shows an example layout of the electro-optical chip, in accordance with some embodiments.

FIG. 4 shows an example layout of a given one of the optical macros, in accordance with some embodiments.

FIG. 5A shows a diagram of a first computer system optically connected to a second computer system through an optical link, in accordance with some embodiments.

FIG. 5B shows a more detailed view of the optical connections between the electro-optical chip of the first computer system and the electro-optical chip of the second computer system, in accordance with some embodiments.

FIG. 6A shows an example implementation of a remote optical power supply for an optical data communication system, in accordance with some embodiments.

FIG. 6B shows a diagram indicating how each of the optical fibers of the M-port optical fiber array receives and conveys each of the multiple wavelengths of CW laser light from the remote optical power supply, in accordance with some embodiments.

FIG. 6C shows an example diagram of the electro-optical chip connected to the M-port optical fiber array that includes optical fibers, in accordance with some embodiments.

FIG. 7A shows an example optical data communication system in which the remote optical power supply is optically connected to supply CW laser light to each of multiple electro-optical chips, in accordance with some embodiments.

FIG. 7B shows a diagram indicating how each of the optical fibers within the first subgroup of optical fibers and each of the optical fibers within the second subgroup of optical fibers receives conveys each of the multiple wavelengths of CW laser light from the remote optical power supply, in accordance with some embodiments.

FIG. 8A shows an example diagram of the first electro-optical chip of FIG. 7A optically connected to the remote optical power supply by way of the optical fibers of the first subgroup of optical fibers, in accordance with some embodiments.

FIG. 8B shows an example diagram of the second electro-optical chip of FIG. 7A optically connected to the remote optical power supply by way of optical fibers of the second subgroup of optical fibers, in accordance with some embodiments.

FIG. 9A shows an example optical data communication system in which a remote optical power supply is optically connected to supply different wavelength groupings of CW laser light to different ones of multiple electro-optical chips, in accordance with some embodiments.

FIG. 9B shows a diagram indicating how each of the optical fibers within the first subgroup of optical fibers receives and conveys each of the multiple wavelengths within a first wavelength grouping of CW laser light from the remote optical power supply, and how each of the optical fibers within the second subgroup of optical fibers receives and conveys each of the multiple wavelengths within a second wavelength grouping of CW laser light from the remote optical power supply, in accordance with some embodiments.

FIG. 9C shows a variation of the example optical data communication system of FIG. 9A in which a given one of the multiple electro-optical chips is optically connected to multiple optical fibers that convey different subsets of the wavelengths of CW laser light, in accordance with some embodiments.

FIG. 10A shows an example diagram of the first electro-optical chip of FIG. 8A optically connected to the remote optical power supply of FIG. 9A by way of the optical fibers of the first subgroup of optical fibers, in accordance with some embodiments.

FIG. 10B shows an example diagram of the second electro-optical chip of FIG. 8B optically connected to the remote optical power supply of FIG. 9A by way of the optical fibers of the second subgroup of optical fibers, in accordance with some embodiments.

FIG. 11A shows an example optical data communication system in which a remote optical power supply is optically connected to supply different wavelength groupings of CW laser light to each of multiple electro-optical chips, in accordance with some embodiments.

FIG. 11B shows a diagram indicating how each of the optical fibers within the first subgroup of optical fibers receives and conveys either the first subgroup of wavelengths of CW laser light or the second subgroup of wavelengths of CW laser light from the remote optical power supply, and how each of the optical fibers within the second subgroup of optical fibers receives and conveys either the first subgroup of wavelengths of CW laser light or the second subgroup of wavelengths of CW laser light from the remote optical power supply, in accordance with some embodiments.

FIG. 12A shows an example diagram of the first electro-optical chip of FIG. 11A optically connected to the remote optical power supply of FIG. 11A by way of the optical fibers of the first subgroup of optical fibers, in accordance with some embodiments.

FIG. 12B shows an example diagram of the second electro-optical chip of FIG. 11A optically connected to the remote optical power supply of FIG. 11A by way of the optical fibers of the second subgroup of optical fibers, in accordance with some embodiments.

FIG. 12C shows an example diagram of an electro-optical chip that implements an (N+P)×M distribution network to distribute light to the plurality of transmit macros, and to provide a number P of spare optical input ports, in accordance with some embodiments.

FIG. 12D shows an example diagram of an electro-optical chip that implements an N×M distribution network to distribute light to the plurality of transmit macros, in accordance with some embodiments.

FIG. 12E shows an example diagram of the electro-optical chip that implements the N×M distribution network as a number Z of 2×2 distribution networks to distribute light to the plurality of transmit macros, in accordance with some embodiments.

FIG. 13 shows a flowchart of a method for optical data communication, in accordance with some embodiments.

FIG. 14 shows a flowchart of a method for optical data communication, in accordance with some embodiments.

FIG. 15 shows a flowchart of a method for optical data communication, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

The embodiments disclosed herein relate to optical data communication. Optical data communication systems operate by modulating laser light to encode digital data patterns within optical data signals. In some embodiments, a ring modulator is used to modulate continuous wave (CW) laser light to generate the modulated laser light that conveys the encoding of digital data patterns. In some embodiments, the ring modulator is positioned within an evanescent optically coupling distance from a bus optical waveguide and operates to modulate light that is propagating through the bus optical waveguide. The modulated laser light is transmitted through an optical data network from a sending node to a receiving node. The modulated laser light having arrived at the receiving node is de-modulated to obtain the original digital data patterns from the optical data signals. The transmission of light through the optical data network includes transmission of light through optical fibers and transmission of light between optical fibers and photonic integrated circuits. In some embodiments, a photodiode is used to detect light of an optical data signal and convert the detected light into a photocurrent that can be processed through electrical circuitry to demodulate the optical data signal to obtain the original digital data pattern from the optical data signal.

Optical cavities are used in a variety of applications in optical data communication systems, in various devices, such as lasers, optical modulators, optical splitters, optical routers, optical switches, and optical detectors, among others. In various applications and configurations, optical cavities may show strong wavelength selectivity. For this reason, optical cavities are useful in systems that rely on multiple optical data signals transmitting information at different wavelengths. In some embodiments, optical cavities are configured as ring resonators and/or disk resonators to enable applications in which light that is coupled from an input optical waveguide into the optical cavity of the ring/disk resonator is either efficiently routed to a separate output optical waveguide, or absorbed within the optical cavity of the ring/disk resonator at specific wavelengths. Also, optical cavities, such as ring/disk resonators, are useful in sensing applications, such as in biological or chemical sensing applications in which a high concentration of optical power is needed in a small area.

High bandwidth, multi-wavelength WDM (Wavelength-Division Multiplexing) systems are necessary to meet the needs of increasing interconnect bandwidth requirements. In some implementations of these WDM systems, a laser source includes a remote laser array configured to generate multiple wavelengths of CW laser light which are combined through an optical distribution network to provide multiple wavelengths of laser light to each of many optical output ports of the laser source. The multiple wavelengths of laser light are transmitted from any one or more of the optical output ports of the laser source to an electro-optical chip, such as to a CMOS (Complementary Metal Oxide Semiconductor) and/or an SOI (silicon-on-insulator) photonic/electronic chip, that sends and receives data in an optical data communication system. In some embodiments, the multi-wavelength laser light source includes an array of lasers that have outputs optically connected to respective optical inputs of an optical distribution network that routes each incoming wavelength of CW laser light to each of multiple optical output ports of the optical distribution network. The multiple wavelengths of CW laser light are then routed from a given optical output port of the optical distribution network to a given optical input supply port of the electro-optical chip.

In some embodiments, the multi-wavelength laser light source includes an array of lasers that have outputs optically connected to respective optical fibers. Each laser in the array of lasers is configured to generate a single wavelength of CW laser light. And, each laser in the array of lasers is configured to generate a different wavelength of CW than the other lasers in the array of lasers. In these embodiments, the optical fibers convey the respective wavelengths of CW laser light to respective optical supply inputs of the electro-optical chip. The optical supply inputs of the electro-optical chip are optically connected to an optical distribution network onboard the electro-optical chip. Each of multiple optical inputs of the optical distribution network is optically connected to receive a respective wavelength of CW laser light by way of a respective optical fiber from a respective laser within the array of lasers of the multi-wavelength laser light source. The optical distribution network onboard the electro-optical chip is configured to route each incoming wavelength of CW laser light to each of multiple optical outputs of the optical distribution network, such that each of the multiple wavelengths of CW laser light received across the multiple optical inputs of the optical distribution network is conveyed to each of the multiple optical outputs of the optical distribution network. The multiple wavelengths of CW laser light are then routed from a given optical output of the optical distribution network onboard the electro-optical chip to an optical supply input of a transmitter portion of a given optical macro within the electro-optical chip.

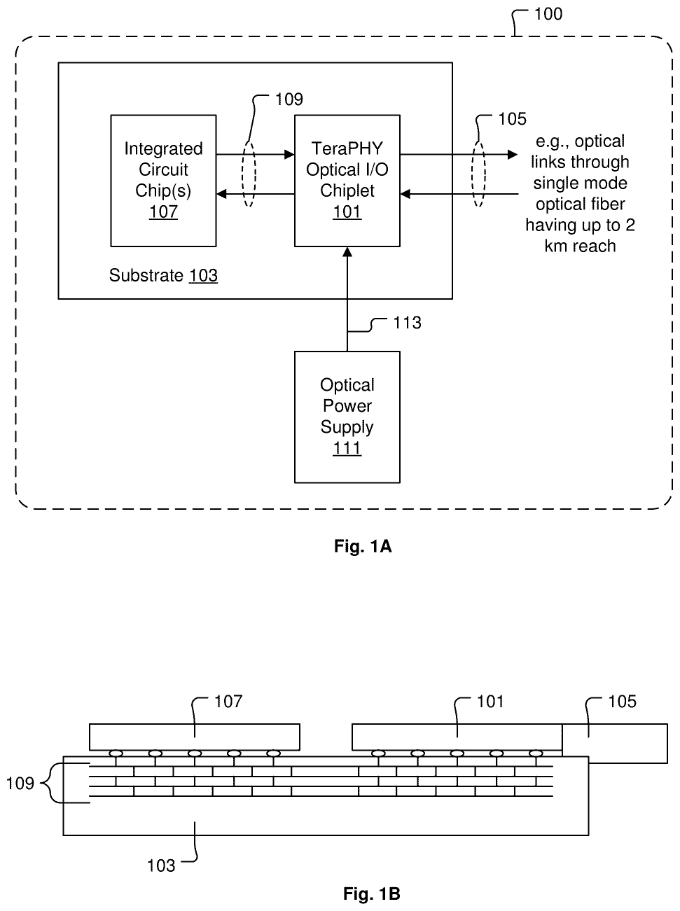

FIG. 1A shows an example block-level architecture of a system 100 implementing an electro-optical chip 101, in accordance with some embodiments. In some embodiments, the electro-optical chip 101 is the TeraPHY™ chip produced by Ayar Labs, Inc., of Santa Clara, California, as described in U.S. patent application Ser. No. 17/184,537, which is incorporated herein by reference in its entirety for all purposes. The system 100 shows a general representation of a multi-chip package (MCP) that is implemented to include the electro-optical chip 101. The system 100 includes the electro-optical chip 101 attached to a substrate 103. The electro-optical chip 101 includes an optical interface that is optically connected to an optical link 105 through which bi-directional optical data communication is performed with another electro-optic device, such as with another electro-optical chip 101. In some embodiments, the system 100 also includes one or more integrated circuit chips 107 (semiconductor chips) attached to the substrate 103. In various embodiments, the one or more integrated circuit chips 107 includes one or more of a central processing unit (CPU), a graphics processing unit (GPU), a visual processing unit (VPU), an application specific integrated circuit (ASIC), a field programmable gate array (FPGA), a memory chip, an HBM stack, an SoC, a microprocessor, a microcontroller, a digital signal processor (DSP), an accelerator chip, and/or essentially any other type of semiconductor chip. In various embodiments, the substrate 103 is an organic package and/or interposer. In some embodiments, the substrate 103 includes electrical connections/routings 109 between the electro-optical chip 101 and the one or more integrated circuit chips 107. In some embodiments, the electrical connections/routings 109 are formed within a redistribution layer (RDL) structure formed within the substrate 103. In various embodiments, the RDL structure is implemented in accordance with essentially any RDL structure topology and technology available within the semiconductor packaging industry. Some of the electrical connections/routings 109 within the substrate 103 are configured and used to provide electrical power and reference ground potential to the electro-optical chip 101 and to each of the one or more semiconductor chips 107. Also, some electrical connections/routings 109 within the substrate 103 are configured and used to transmit electrical signals that provide for bi-directional digital data communication between the electro-optical chip 101 and the one or more semiconductor chips 107. In various embodiments, digital data communication through the electrical connections/routings 109 between the electro-optical chip 101 and the one or more semiconductor chips 107 is implemented in accordance with a digital data interconnect standard, such as the Peripheral Component Interconnect Express (PCIe) standard, the Compute Express Link (CXL) standard, the Gen-Z standard, the Open Coherent Accelerator Processor Interface (OpenCAPI), and/or the Open Memory Interface (OMI), among essentially any other digital data interconnect standard.

The system 100 also includes an optical power supply 111 optically connected to supply CW laser light of one or more controlled wavelengths to the electro-optical chip 101. In some embodiments, the optical power supply 111 is a SuperNova multi-wavelength, multi-port light supply provided by Ayar Labs, Inc. The optical power supply 111 supplies CW light that optically powers the electro-optical chip 101. In some embodiments, the optical power supply 111 is configured as a photonic integrated circuit (PIC) that generates multiple wavelengths of the CW light, multiplexes the multiple wavelengths of CW light onto a common optical fiber or optical waveguide, and splits and amplifies the multiplexed optical power to multiple output ports of the optical power supply 111 for transmission to multiple corresponding CW light input ports of the electro-optical chip 101. In some other embodiments, the optical power supply 111 is configured as an array of lasers, where each laser in the array of lasers is configured to generate a respective wavelength of CW laser light. In these embodiments, the CW laser light generated by a given one of the lasers is transmitted to a respective one of multiple output ports of the optical power supply 111 for transmission to a respective one of multiple CW light input ports of the electro-optical chip 101.

In various embodiments, the optical power supply 111 is optically connected to the electro-optical chip 101 through one or more optical waveguides 113. In various embodiments, the one or more optical waveguides 113 includes one or more optical fibers and/or one or more optical waveguide structures formed within the substrate 103. In some embodiments, the optical power supply 111 is optically connected to the electro-optical chip 101 through an optical fiber array that includes multiple optical fibers, where each optical fiber in the optical fiber array is connected to carry a respective one of the multiple wavelengths of CW light generated by the array of lasers within the optical power supply 111. In some embodiments, the optical power supply 111 is attached to the substrate 103. In some embodiments, the optical power supply 111 receives electrical power and electrical control signals through electrical connections/routings formed within the substrate 103. Alternatively, in some embodiments, the optical power supply 111 is implemented as a device physically separate from the substrate 103. In some of these embodiments, the optical power supply 111 is physically remote from the electro-optical chip 101. In some of these embodiments, the optical power supply 111 is optically connected to the electro-optical chip 101 through one or more optical fibers that are optically connected to the substrate 103 and through one or more optical waveguides formed within the substrate 103.

FIG. 1B shows a vertical cross-section diagram of the substrate 103 of FIG. 1A, in accordance with some embodiments. In some embodiments, the electrical connections/routings 109 of the RDL structure(s) are formed in multiple levels of the substrate 103. In some embodiments, the electrical connections/routings 109 include electrically conductive via structures formed to provide electrical connections between electrical traces formed in different levels of the substrate 103, as represented by the vertical lines between different levels of the electrical connections/routings 109 in FIG. 1B. It should be understood that in various embodiments the electrical connections/routings 109 are configured in essentially any manner as needed to provide required electrical connectivity between the integrated circuit chip(s) 107 and the electro-optical chip 101, and to provide electrical power to each of the integrated circuit chip(s) 107 and the electro-optical chip 101, and to provide a reference ground potential connection to each of the integrated circuit chip(s) 107 and the electro-optical chip 101.

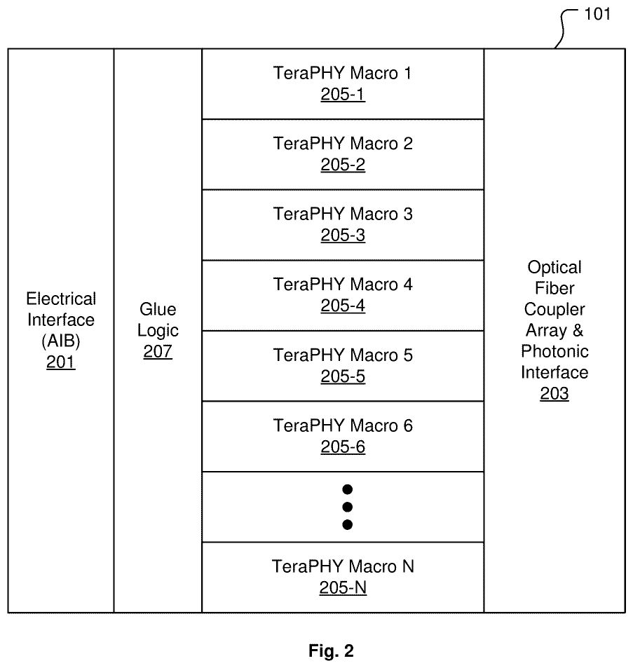

FIG. 2 shows an example organizational diagram of the electro-optical chip 101 referenced herein, in accordance with some embodiments. The organizational diagram has an electrical interface 201 separated (split) from a photonic interface 203. The photonic interface 203 is configured to optically couple with an optical fiber array. In the example of FIG. 2, the electrical interface 201 is on a left side of the electro-optical chip 101, and the photonic interface 203 is on a right side of the electro-optical chip 101. A number (1 to N) of optical macros 205-1 to 205-N are located between the photonic interface 203 and the electrical interface 201. The electrical interface 201 is connected to the optical macros 205-1 to 205-N by glue logic 207. The electrical interface 201 of the electro-optical chip 101 is adaptable to the logic of an integrated circuit chip to which the electro-optical chip 101 connects. In the example of FIG. 2, the flow of data from electronics-to-optics is from left-to-right, and the flow of data from optics-to-electronics is from right-to-left.

The electrical interface 201 is a block of circuitry configured to handle all electrical I/O to and from the integrated circuit chip to which the electro-optical chip 101 connects, such as an Ethernet switch chip/die, or other type of integrated circuit chip. The optical macros 205-1 to 205-N are responsible for conversion of data signals between the optical and electrical domains. Specifically, each of the optical macros 205-1 to 205-N is configured to convert electrical data signals received through the electrical interface 201 into optical data signals for transmission through the photonic interface 203. Also, each of the optical macros 205-1 to 205-N is configured to convert optical data signals received through the photonic interface 203 into electrical data signals for transmission through the electrical interface 201. The photonic interface 203 is responsible for coupling optical signals to and from the optical macros 205-1 to 205-N. The glue logic 207 enables flexible (dynamic or static) mapping of the electrical interface 201 to the optical macros 205-1 to 205-N and associated optical wavelengths. In this manner, the glue logic 207 (also called crossbar circuitry) provides dynamic routing of electrical signals between the optical macros 205-1 to 205-N and the electrical interface 201. The glue logic 207 also provides for retiming, rebuffering, and flit reorganization functions at the phy-level. Also, in some embodiments, the glue logic 207 implements various error correction and data-level link protocols to offload some processing from the integrated circuit chip to which the electro-optical chip 101 connects.

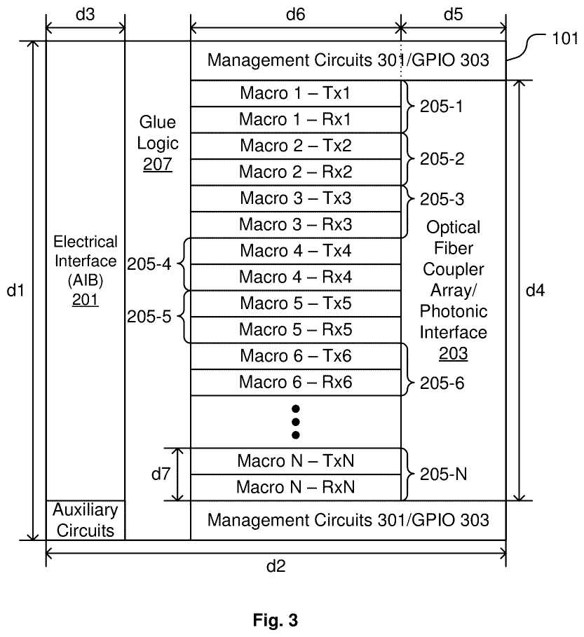

FIG. 3 shows an example layout of the electro-optical chip 101, in accordance with some embodiments. The layout of the optical and electrical components of the electro-optical chip 101 is designed to optimize area efficiency, energy efficiency, performance, and practical considerations such as avoiding optical waveguide crossings. In some embodiments, the electrical interface 201 is laid out along one chip edge (left side edge in FIG. 3), and the photonic interface 203 for optical coupling with the optical fiber array is laid out along the opposite chip edge (right side edge in FIG. 3). In some embodiments, the photonic interface 203 includes an optical grating coupler for each of the optical fibers in the optical fiber array. In various embodiments, the photonic interface 203 includes vertical optical grating couplers, edge optical couplers, or essentially any other type of optical coupling device, or combination thereof to enable optical coupling of the optical fibers in the optical fiber array with the optical macros 205-1 to 205-N. In some embodiments, the photonic interface 203 is configured to interface with 24 optical fibers within the optical fiber array. In some embodiments, the photonic interface 203 is configured to interface with 16 optical fibers within the optical fiber array. However, in various embodiments, the photonic interface 203 can be configured to interface with essentially any number of optical fibers within the optical fiber array.

The glue logic 207 routes data between the electrical interface 201 and the optical macros 205-1 to 205-N. The glue logic 207 includes cross-bar switches and other circuitry as needed to interface the electrical interface 201 connections with the optical macros 205-1 to 205-N. In some embodiments, the optical transmitters (Tx) and optical receivers (Rx) of the optical macros 205-1 to 205-N are combined in pairs, with each Tx/Rx pair forming an optical transceiver. The glue logic 207 enables dynamic mapping of electrical lanes/channels to optical lanes/channels. The optical macros 205-1 to 205-N (for data transmitting (Tx) and data receiving (Rx)) are laid out in between the glue logic 207 and the photonic interface 203 that couples with the optical fibers of the optical fiber array. The optical macros 205-1 to 205-N include both optical and electrical circuitry responsible for converting electrical signals to optical signals and for converting optical signals to electrical signals.

In some embodiments, the electrical interface 201 is configured to implement the Advanced Interface Bus (AIB) protocol to enable electrical interface between the electro-optical chip 101 and one or more other integrated circuit chips. It should be understood, however, that in other embodiments the electrical interface 201 can be configured to implement essentially any electrical data communication interface other than AIB. For example, in some embodiments, the electrical interface 201 includes a High Bandwidth Memory (HBM) and a high-speed serial electrical interface for serialization/deserialization of data. In some embodiments, the electrical interface 201 is implemented as a Universal Chiplet Interconnect Express (UCIe) interface.

In some embodiments, the electro-optical chip 101 has a length d1 and a width d2, where d1 is about 8.9 millimeters (mm) and d2 is about 5.5 mm. It should be understood that the term “about,” as used herein, means +/−10% of a given value. In some embodiments, the length d1 is less than about 8.9 mm. In some embodiments, the length d1 is greater than about 8.9 mm. In some embodiments, the width d2 is less than about 5.5 mm. In some embodiments, the width d2 is greater than about 5.5 mm. In some embodiments, the electrical interface 201 has a width d3 of about 1.3 mm. In some embodiments, the width d3 is less than about 1.3 mm. In some embodiments, the width d3 is greater than about 1.3 mm. In some embodiments, the photonic interface 203 for the optical fiber array has a length d4 of about 5.2 mm and a width d5 of about 2.3 mm. In some embodiments, the length d4 is less than about 5.2 mm. In some embodiments, the length d4 is greater than about 5.2 mm. In some embodiments, the optical macros 205-1 to 205-N have a width d6 of about 1.8 mm. In some embodiments, the width d6 is less than about 1.8 mm. In some embodiments, the width d6 is greater than about 1.8 mm. In some embodiments, each transmitter Tx and receiver Rx optical macro 205-1 to 205-N pair has a length d7 of about 0.75 mm. In some embodiments, the length d7 is less than about 0.75 mm. In some embodiments, the length d7 is greater than about 0.75 mm. In some embodiments, the transmitter Tx and receiver Rx optical macros 205-1 to 205-N are positioned to align with an optical fiber pitch within the photonic interface 203. In some embodiments, the length d7 of each optical macro 205-1 to 205-N (pair of transmitter (Tx) and receiver (Rx) optical macros) is matched to the pitch of the optical fibers in a standard optical fiber ribbon. For example, if the optical fiber pitch is 250 micrometers, and three of the optical fibers in the optical fiber ribbon correspond to one optical macro 205-1 to 205-N (one optical fiber brings CW light to the transmitter (Tx) optical macro from a laser, one optical fiber carries modulated light from the transmitter (Tx) optical macro, and one optical fiber brings modulated light representing encoded data to the receiver (Rx) optical macro), then the optical macro length d7 is 750 micrometers.

In some embodiments, the number N of optical macros 205-1 to 205-N is 8. In some embodiments, the number N of optical macros 205-1 to 205-N is less than 8. In some embodiments, the number N of optical macros 205-1 to 205-N is greater than 8. Also, each of the optical macros 205-1 to 205-N represents at least one optical port. In some embodiments, a dual phase lock loop (PLL) circuit is shared by each transmitter Tx/receiver Rx pair within the optical macros 205-1 to 205-N. In some embodiments, the dual PLL includes a PLLU that covers a frequency range from 24 GigaHertz (GHz) to 32 GHz, and a PLLD that covers a frequency range from 15 GHz to 24 GHz.

The electro-optical chip 101 also includes management circuits 301 and general purpose input/output (GPIO) components 303 for communicating electrical data signals to and from the electro-optical chip 101. In various embodiments, the GPIO components 303 include Serial Peripheral Interface (SPI) components and/or another type of component to enable off-chip data communication. Also, in some embodiments, the electro-optical chip 101 includes many other circuits, such as memory (e.g., SRAM), a CPU, analog circuits, and/or any other circuit that is implementable in CMOS. In some embodiments, the electro-optical chip 101 has a coarse wavelength division multiplexing 4-lane (CWDM4) configuration in which each of the optical macros 205-1 to 205-N includes four serializer/deserializer (SerDes) slices (FR-4) or eight SerDes slices (FR-8). In some embodiments, the optical macros 205-1 to 205-N are divided into wavelength transmit (Tx)/receive (Rx) slices, with each Tx/Rx slice including fully integrated analog Tx/Rx front-ends, serialization/deserialization, clock-data-recovery, and microring resonator thermal tuning digital control. In some embodiments, the photonic components integrated in each Tx/Rx slice/optical macro 205-x optical port are based on microring resonators (such as modulators, filters, etc.). In some embodiments, the electro-optical chip 101 optically couples to the optical fiber of the optical fiber array through edge-coupled V-groove structures with embedded mode-converters.

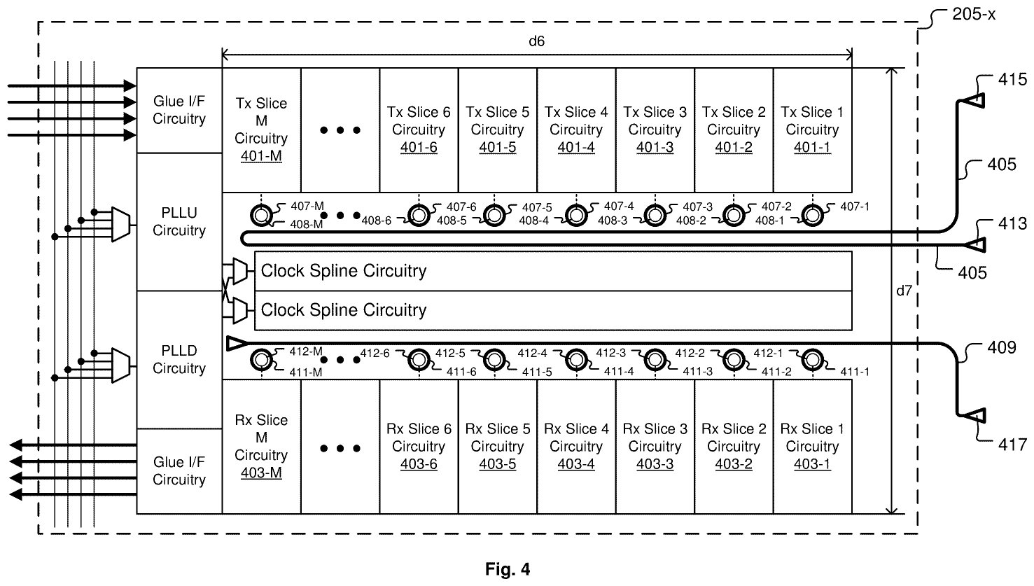

FIG. 4 shows an example layout of a given one of the optical macros 205-1 to 205-N, referred to as optical macro 205-x, in accordance with some embodiments. The optical macro 205-x includes a number M of transmit (Tx) slices 401-1 to 401-M and a number M of receive (Rx) slices 403-1 to 403-M. An optical slice of the optical macro 205-x refers to either a single one of the optical transmitter slices 401-1 to 401-M, or a single one of the optical receiver slices 403-1 to 403-M, or a combination of a single one of the optical transmitter slices 401-1 to 401-M and a corresponding single one of the optical receiver slices 403-1 to 403-M, where the single one of the optical transmitter slices 401-1 to 401-M and the single one of the optical receiver slices 403-1 to 403-M are controlled to operate on a single wavelength of light. The example layout of FIG. 4 shows the routing of an optical waveguide 405 and the placement of optical microring resonators 407-1 to 407-M within the transmit (Tx) portion of the optical macro 205-x. In some embodiments, the microring resonators 407-1 to 407-M function as modulators. The example layout of FIG. 4 also shows the routing of an optical waveguide 409 and the placement of optical microring resonators 411-1 to 411-M within the receive (Rx) portion of the optical macro 205-x. In some embodiments, the microring resonators 411-1 to 411-M function as photodetectors. In some embodiments, one or more of the microring resonators 407-1 to 407-M and 411-1 to 411-M are controlled to function as an optical multiplexer and/or as an optical demultiplexer.

Each corresponding pair of the transmit (Tx) slices 401-1 to 401-M and the receive (Rx) slices 403-1 to 403-M forms a Tx/Rx slice of the optical macro 205-x. For example, Tx Slice 1 401-1 and Rx Slice 1 403-1 together form a Slice 1 of the optical macro 205-x. The transmit (Tx) slices 401-1 to 401-M include electrical circuitry for directing translation of electrical data in the form of a bit stream into a stream of modulated light by operating the microring resonators 407-1 to 407-M to modulate the CW laser light at a given wavelength incoming through the optical waveguide 405 from an optical supply input 413 into a stream of modulated light at the given wavelength, with the stream of modulated light at the given wavelength being transmitted from the optical macro 205-x through the optical waveguide 405 to the optical signal output 415. In some embodiments, each of the transmit (Tx) slices 401-1 to 401-M includes electrical circuitry for in-phase signal generation and/or quadrature signal generation, injection locked oscillator circuitry, and phase interpolator circuitry. The receive (Rx) slices 403-1 to 403-M include electrical circuitry for detecting light of a given wavelength within a stream of modulated light incoming through the optical waveguide 409 from an optical signal input 417 by operating the microring resonators 411-1 to 411-M. The electrical circuitry within the receive (Rx) slices 403-1 to 403-M translate the light that is detected by the microring resonators 411-1 to 411-M at a corresponding wavelength into a bit stream in the electrical domain. In some embodiments, each of the receive (Rx) slices 403-1 to 403-M includes electrical circuitry for in-phase signal generation and/or quadrature signal generation (I/Q signal generation), injection locked oscillator (ILO) circuitry, phase interpolator (PI) circuitry, transimpedance amplifier (TIA) circuitry, and signal equalization (EQ) circuitry. In some embodiments, the receive (Rx) slices 403-1 to 403-M utilize a respective dummy microring photodetector (PD) for better matching in the receiver analog front-end and for robustness to common-mode noise (e.g., supply).

The optical waveguide 405 routes CW laser light from the optical supply input 413 to each of the microring resonators 407-1 to 407-M within the transmit (Tx) slices 401-1 to 401-M. The optical waveguide 405 also routes modulated light from the microring resonators 407-1 to 407-M within the transmit (Tx) slices 401-1 to 401-M to the optical signal output 415 for transmission out of the electro-optical chip 101. In some embodiments, each of the microring resonators 407-1 to 407-M within the transmit (Tx) slices 401-1 to 401-M is tunable to operate at a specified wavelength of light. Also, in some embodiments, the specified wavelength of light at which a given microring resonator 407-x is tuned to operate is different than the specified wavelengths at which the other microring resonators 407-1 to 407-M, excluding 407-x, are tuned to operate. In some embodiments, a corresponding heating device 408-1 to 408-M is positioned near each of the microring resonators 407-1 to 407-M to provide for thermal tuning of the resonant wavelength of the microring resonator. In some embodiments, a corresponding heating device 408-1 to 408-M is positioned within an inner region circumscribed by a given microring resonator 407-x to provide for thermal tuning of the resonant wavelength of the given microring resonator 407-x. In some embodiments, the heating device 408-1 to 408-M of each of the microring resonators 407-1 to 407-M is connected to corresponding electrical control circuitry within the corresponding transmit (Tx) slice that is operated to thermally tune the resonant wavelength of the microring resonator. In some embodiments, each of the microring resonators 407-1 to 407-M is connected to corresponding electrical tuning circuitry within the corresponding transmit (Tx) slice that is operated to electrically tune the resonant wavelength of the microring resonator. In various embodiments, each of the microring resonators 407-1 to 407-M operates as part of an optical modulator and/or optical multiplexer.

The optical waveguide 409 routes incoming modulated light from the optical signal input 417 to the microring resonators 411-1 to 411-M within the receive (Rx) slices 403-1 to 403-M. In some embodiments, each of the microring resonators 411-1 to 411-M within the receive (Rx) slices 403-1 to 403-M is tunable to operate at a specified wavelength of light. Also, in some embodiments, the specified wavelength of light at which a given microring resonator 411-x is tuned to operate is different than the specified wavelengths at which the other microring resonators 411-1 to 411-M, excluding 411-x, are tuned to operate. In some embodiments, a corresponding heating device 412-1 to 412-M is positioned near each of the microring resonators 411-1 to 411-M to provide for thermal tuning of the resonant wavelength of the microring resonator. In some embodiments, a corresponding heating device 412-1 to 412-M is positioned within an inner region circumscribed by a given microring resonator 411-x to provide for thermal tuning of the resonant wavelength of the given microring resonator 411-x. In some embodiments, the heating device 412-1 to 412-M of each of the microring resonators 411-1 to 411-M is connected to corresponding electrical control circuitry within the corresponding receive (Rx) slice that is operated to thermally tune the resonant wavelength of the microring resonator. In some embodiments, each of the microring resonators 411-1 to 411-M is connected to corresponding electrical tuning circuitry within the corresponding receive (Rx) slice that is operated to electrically tune the resonant wavelength of the microring resonator. In various embodiments, each of the microring resonators 411-1 to 411-M operates as part of a photodetector and/or optical demultiplexer.

In some embodiments, the architecture and floorplan of the optical macro 205-x is variable by including a different number of PLLs at various positions within the optical macro 205-x. For example, in some embodiments, a centralized PLL is positioned within the clock spine and fans out to the slices at both sides of the optical macro 205-x. In various embodiments, the PLL is replicated as multiple PLL instances across the optical macro 205-x, with each PLL instance either dedicated to a given transmit (Tx)/receive (Rx) slice or shared with a subset of transmit (Tx)/receive (Rx) slices. In various embodiments, other floorplan configurations of the optical macro 205-x include multiple columns of optical macros with pass-through photonic rows, to increase the edge bandwidth density, and/or staggering of the transmit (Tx) and receive (Rx) optical macros side-by-side to increase the edge bandwidth density.

The optical macro 205-x includes both photonic and electronic components. The optical waveguides 405 and 409 are laid out in the optical macro 205-x so as to avoid optical waveguide crossings and so as to minimize optical waveguide length, which minimizes optical losses, and correspondingly improves the energy efficiency of the system. The optical macro 205-x is laid out in such a way as to minimize the distance between the electronic components and the optical components in order to minimize electrical trace length, which improves the energy efficiency of the optical macro 205-x, enables faster signal transmission, and reduces chip size.

The electro-optical chip 101 includes the set of (N) optical macros 205-1 to 205-N. Each optical macro 205-x includes the set of (M) optical transmitter slices 401-1 to 401-M and optical receiver slices 403-1 to 403-M that are logically grouped together to transmit or receive bits on a number (W) of different optical wavelengths on the respective optical waveguide 405 and 409. In various embodiments, the number (M) of optical transmitter slices 401-1 to 401-M and optical receiver slices 403-1 to 403-M and the number (W) of different optical wavelengths can be defined as needed, considering that any number of optical transmitter slices 401-1 to 401-M and/or optical receiver slices 403-1 to 403-M is tunable to a given one of the number (W) of optical wavelengths. However, if data bits are being transmitted or received by multiple ones of the optical microring resonators 407-1 to 407-M, or by multiple ones of the optical microring resonators 411-1 to 411-M, tuned to the same optical wavelength, channel/wavelength contention is managed. The floorplan and organization of the optical macro 205-x represent adjustable degrees of freedom for controlling the following metrics: length of optical waveguides 405 and 409 (which directly correlates with optical loss); optical macro 205-x area (which correlates with manufacturing cost); energy consumed per bit (energy efficiency); electrical signaling integrity (which correlates with performance); electrical package escape (the amount of electrical data input and output that is physically available for a given set of chip dimensions and for a given spacing/pitch of electrical bumps); and optical package escape (the amount of optical data input and output that is physically available for a given set of chip dimensions and for a given spacing/pitch of optical fibers).

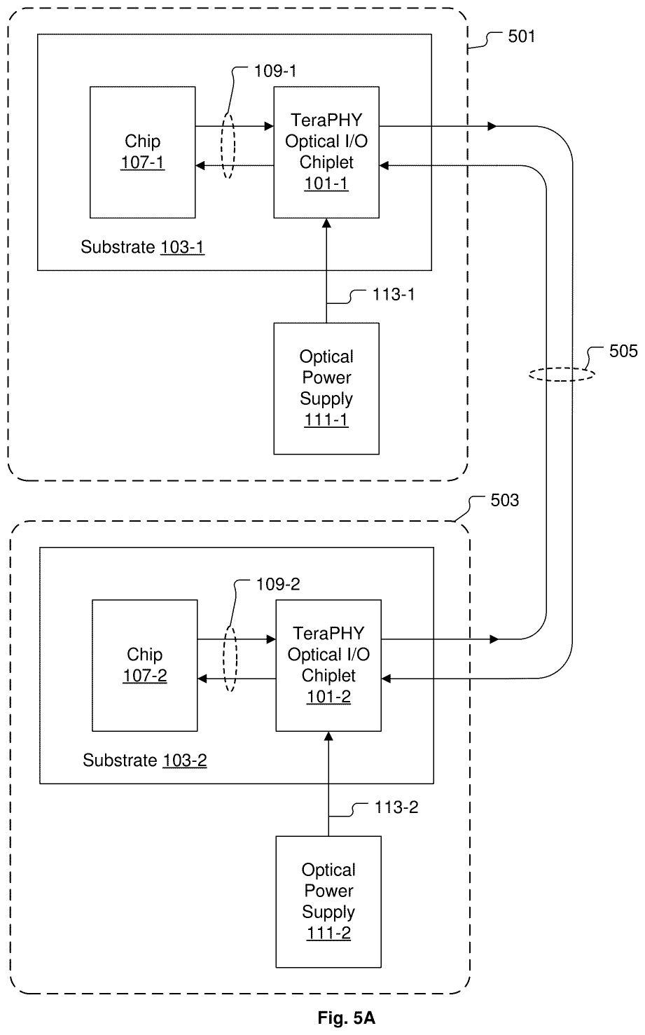

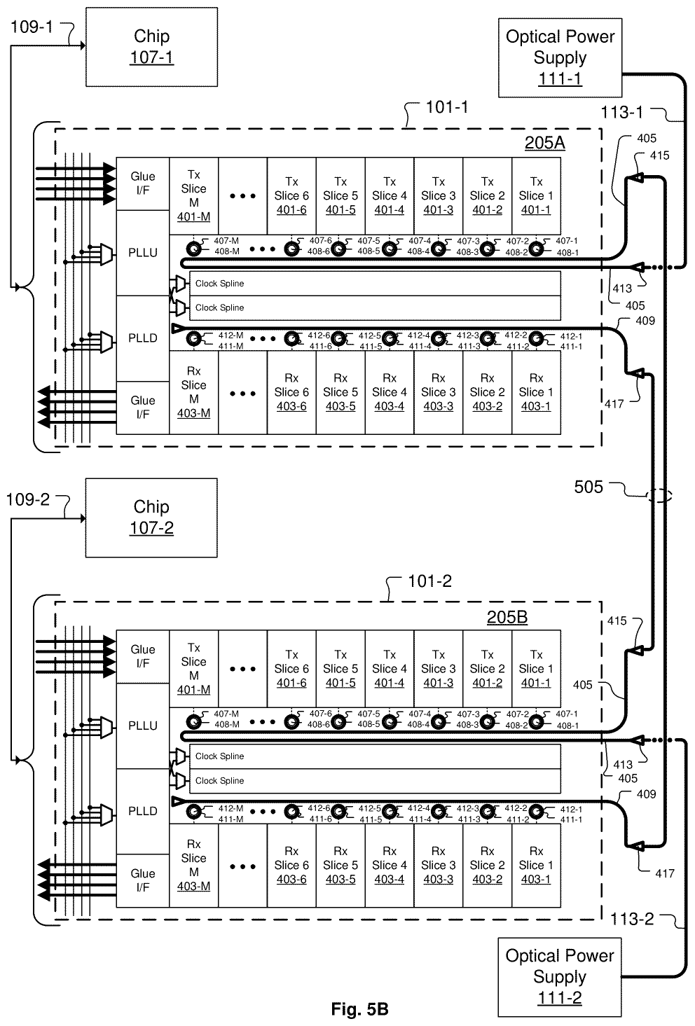

FIG. 5A shows a diagram of a first computer system 501 optically connected to a second computer system 503 through an optical link 505, in accordance with some embodiments. In various embodiments, the first computer system 501 represents essentially any packaged set of semiconductor chips that includes at least one integrated circuit chip 107-1 electrically connected to at least one electro-optical chip 101-1, as indicated by electrical connections/routings 109-1. In some embodiments, the at least one integrated circuit chip 107-1 and the at least one electro-optical chip 101-1 are packaged on a common substrate 103-1. The at least one electro-optical chip 101-1 is connected to receive optical power from an optical power supply 111-1 through one or more optical waveguides 113-1, such as an optical fiber array. The at least one electro-optical chip 101-1 corresponds to the electro-optical chip 101 discussed herein. In some embodiments, the optical power supply 111-1 is the same as the optical power supply 111 described with regard to FIG. 1A.

In various embodiments, the second computer system 503 represents essentially any packaged set of semiconductor chips that includes at least one integrated circuit chip 107-2 electrically connected to at least one electro-optical chip 101-2, as indicated by electrical connections/routings 109-2. In some embodiments, the at least one integrated circuit chip 107-2 and the at least one electro-optical chip 101-2 are packaged on a common substrate 103-2. The at least one electro-optical chip 101-2 is connected to receive optical power from an optical power supply 111-2 through one or more optical waveguides 113-2, such an optical fiber array. The at least one electro-optical chip 101-2 corresponds to the electro-optical chip 101 discussed herein. In some embodiments, the optical power supply 111-2 is the same as the optical power supply 111 described with regard to FIG. 1A. Also, in some embodiments, the optical power supplies 111-1 and 111-2 are the same optical power supply. The electro-optical chip 101-1 of the first computer system 501 is optically connected to the electro-optical chip 101-2 of the second computer system 503 through the optical link 505. In some embodiments, the optical link 505 is an optical fiber array.

FIG. 5B shows a more detailed view of the optical connections between the electro-optical chip 101-1 of the first computer system 501 and the electro-optical chip 101-2 of the second computer system 503, in accordance with some embodiments. In some embodiments, each of the electro-optical chip 101-1 and 101-2 is configured in the same manner as electro-optical chip 101 described herein. The electro-optical chip 101-1 includes at least one optical macro 205A. The electro-optical chip 101-2 includes at least one optical macro 205B. Each of the optical macros 205A and 205B is configured in the same manner as the optical macro 205-x described herein.

The optical supply input 413 of the optical macro 205A is optically connected to the optical power supply 111-1 through one or more optical waveguides 113-1. The optical signal output 415 of the optical macro 205A is optically connected to the optical signal input 417 of the optical macro 205B. In this manner, modulated optical signals generated by the transmitter slices 401-1 through 401-M of the optical macro 205A are transmitted to the receiver slices 403-1 through 403-M of the optical macro 205B. In some embodiments, the modulated optical signals generated by the transmitter slices 401-1 through 401-M convey data received by the optical macro 205A from the integrated circuit chip 107-1 in the form of electrical signals. The modulated optical signals that convey the data are optically coupled into the optical microring resonators 411-1 through 411-M of the optical macro 205B and are de-modulated by the receiver slices 403-1 through 403-M of the optical macro 205B into electrical signals that are transmitted to the integrated circuit chip 107-2 through the electrical connections/routings 109-2.

The optical supply input 413 of the optical macro 205B is optically connected to the optical power supply 111-2 through one or more optical waveguides 113-2. The optical signal output 415 of the optical macro 205B is optically connected to the optical signal input 417 of the optical macro 205A. In this manner, modulated optical signals generated by the transmitter slices 401-1 through 401-M of the optical macro 205B are transmitted to the receiver slices 403-1 through 403-M of the optical macro 205A. In some embodiments, the modulated optical signals generated by the transmitter slices 401-1 through 401-M of the optical macro 205B convey data provided by the integrated circuit chip 107-2 through the electrical connections/routings 109-2 to the optical macro 205B. The modulated optical signals that convey the data provided by the integrated circuit chip 107-2 are optically coupled into the optical microring resonators 411-1 through 411-M of the optical macro 205A and are de-modulated by the receiver slices 403-1 through 403-M of the optical macro 205A into electrical signals that are transmitted to chip 107-1 through the electrical connections/routings 109-1.

The electro-optical chip 101 has a small footprint because the intellectual property (IP) building blocks on the chiplet are dense. These IP building blocks include the optical microring resonators, which are used for multiplexing and demultiplexing multiple wavelengths of light onto optical waveguides, as well as modulating light and functioning as photodetectors, in a very small chip area. In some embodiments, each of the optical microring resonators of the electro-optical chip 101 has an outer diameter of less than 10 micrometers. The IP building blocks on the chip are also dense because the electrical circuitry that controls the optical devices is closely integrated on the same chip with the optical devices that they control, making it possible to optimize space efficiency.

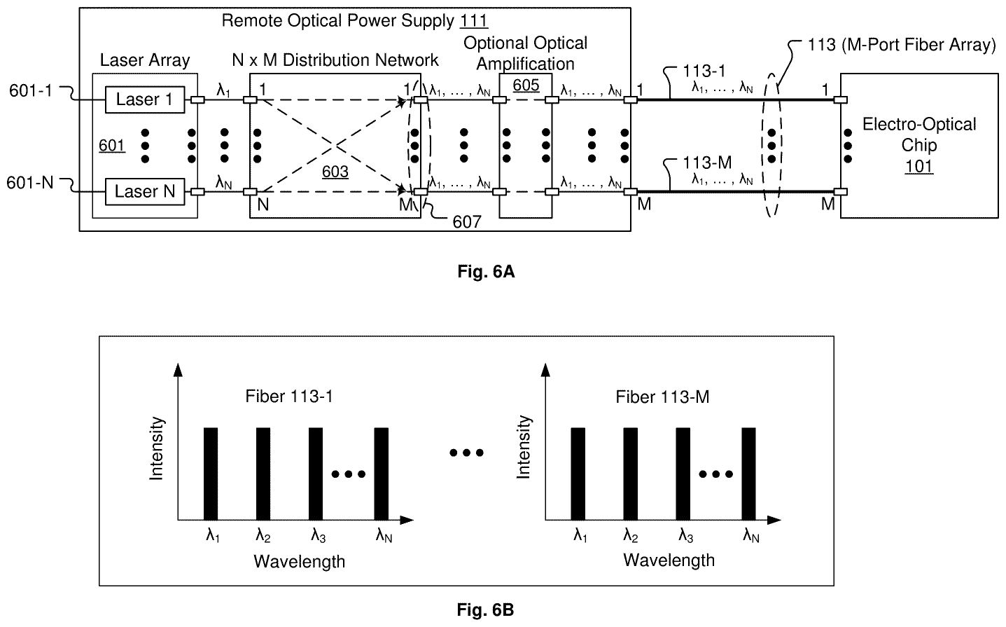

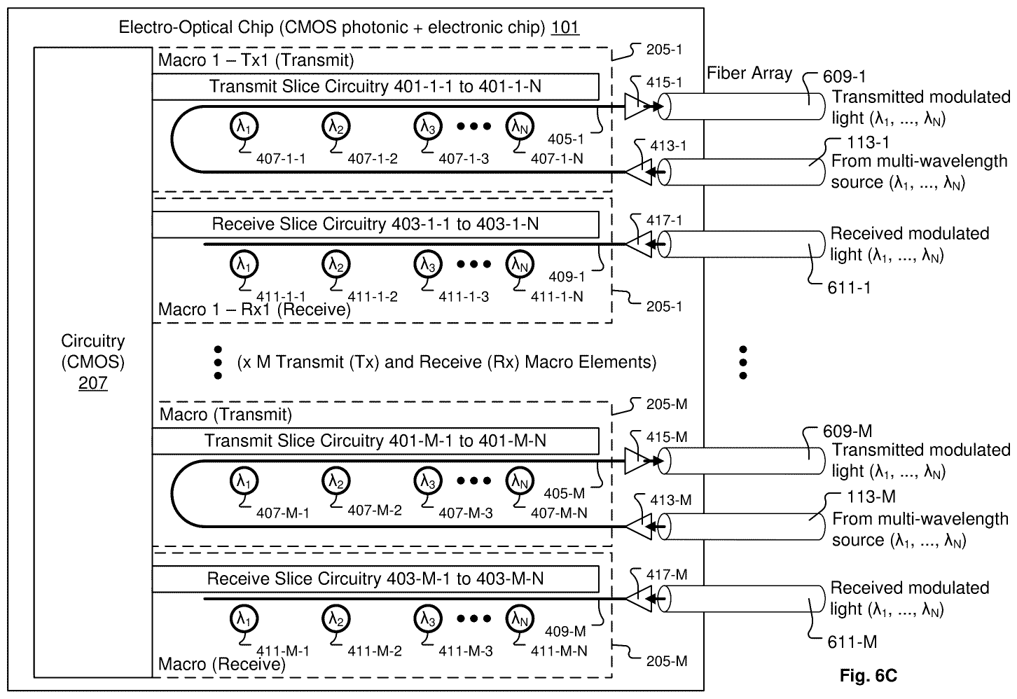

FIG. 6A shows an example implementation of a remote optical power supply 111 for an optical data communication system, in accordance with some embodiments. The remote optical power supply 111 includes a laser array 601, an N×M optical distribution network 603, and an optional optical amplification module 605. The laser array 601 includes a number (N) of lasers 601-1 to 601-N, where N is greater than one. Each laser 601-1 to 601-N is configured to generate and output CW laser light of a different wavelength λ₁ to λ_{N}, respectively. The optical distribution network 603 routes the laser light at each of the N wavelengths, as generated by the multiple laser elements 601-1 through 601-N, to each of a number (M) of optical output ports 607 of the optical distribution network 603. In some embodiments, the optional optical amplification module 605 is not present and the multiple wavelengths (λ₁ to λ_{N}) of CW laser light that are directed to a given one of the (M) optical output ports 607 of the optical distribution network 603 are transmitted directly into a corresponding one of the optical fibers 113-1 to 113-M of an M-port optical fiber array 113. In some embodiments, the optional optical amplification module 605 is present and the multiple wavelengths (λ₁ to λ_{N}) of CW laser light that are directed to a given one of the (M) optical output ports 607 of the optical distribution network 603 are transmitted through the optical amplification module 605 for amplification in route to a corresponding one of the optical fibers 113-1 to 113-M of the M-port optical fiber array 113. In this manner, the remote optical power supply 111 operates to provide multiple wavelengths (λ₁ to λ_{N}) of CW laser light on each of the multiple optical fibers 113-1 to 113-M of the M-port optical fiber array 113. In some embodiments, each of the optical fibers 113-1 to 113-M of the M-port optical fiber array 113 is connected to route the multiple wavelengths (λ₁ to λ_{N}) of CW laser light that it receives from the remote optical power supply 111 to a corresponding optical supply port on the electro-optical chip 101, such as to the optical supply inputs 413 corresponding to the transmit macros on the electro-optical chip 101 as described with regard to FIG. 4.

FIG. 6B shows a diagram indicating how each of the optical fibers 113-1 to 113-M of the M-port optical fiber array 113 receives and conveys each of the multiple wavelengths (λ₁ to λ_{N}) of CW laser light from the remote optical power supply 111, in accordance with some embodiments. In some embodiments, each of the multiple wavelengths (λ₁ to λ_{N}) of CW laser light is output from the remote optical power supply 111 at a substantially equal intensity (power). However, in some embodiments, the optical power level of one or more of the multiple wavelengths (λ₁ to λ_{N}) of CW laser light as output from the remote optical power supply 111 is different than the optical power levels of others of the multiple wavelengths (λ₁ to λ_{N}) of CW laser light as output from the remote optical power supply 111.

FIG. 6C shows an example diagram of the electro-optical chip 101 connected to the M-port optical fiber array 113 that includes optical fibers 113-1 to 113-M, in accordance with some embodiments. The electro-optical chip 101 includes the number (M) of transmit/receive macros 205-1 to 205-M. Each transmit/receive macro 205-1 to 205-M includes a transmit macro having the microring resonators 407-x-1 to 407-x-M and corresponding transmit slice circuitry 401-x-1 to 401-x-N, where x identifies the particular one of the M transmit/receive macros 205-1 to 205-M. Each transmit/receive macro 205-1 to 205-M also includes a receive macro having the microring resonators 411-x-1 to 411-x-M and corresponding receive slice circuitry 403-x-1 to 403-x-N, where x identifies the particular one of the M transmit/receive macros 205-1 to 205-M. Each transmit/receive macro 205-1 to 205-M includes an optical supply input 413-1 to 413-M, respectively, that is connected to a corresponding one of the optical fibers 113-1 to 113-M, respectively, to receive the multi-wavelength (λ₁ to λ_{N}) CW laser light from the remote optical power supply 111. In some embodiments, the number (M) of optical fibers 113-1 to 113-M required from the remote optical power supply 111 equals the number of transmit/receive macros 205-1 to 205-M of the electro-optical chip 101.

The optical supply inputs 413-1 to 413-M are connected to optical waveguides 405-1 to 405-M, respectively. Each of the optical waveguides 405-1 to 405-M extends past the number (N) of microring resonators 407-x-1 to 407-x-N, where x identifies the particular one of the M transmit/receive macros 205-1 to 205-M, so as to enable evanescent coupling of light between the optical waveguides 405-1 to 405-M and the corresponding set of microring resonators 407-x-1 to 407-x-N. Each of the microring resonators 407-x-1 to 407-x-N is operated as an optical ring modulator tuned to a corresponding one of the N wavelengths (λ₁ to λ_{N}) of the incoming CW laser light. Each of the microring resonators 407-x-1 to 407-x-N is controlled by the corresponding transmit slice circuitry 401-x-1 to 401-x-N to function as an optical ring modulator to modulate the incoming CW laser light of a particular wavelength (λ_{y}, where y is in the set of 1 to N) on the corresponding optical waveguide 405-1 to 405-M in accordance with electrical signals that represent digital data, so as to generate modulated light of the corresponding wavelength (λ_{y}) that has a modulation pattern that conveys the digital data represented by the electrical signals. After extending past each of the microring resonators 407-x-1 to 407-x-N, each of the optical waveguides 405-1 to 405-M extends to a respective optical signal output 415-1 to 415-M. The modulated light is transmitted from the optical signal outputs 415-1 to 415-M into respective optical fibers 609-1 to 609-M that carry the modulated light to a destination somewhere within the optical data communication system.

Each receive macro of the transmit/receive macros 205-1 to 205-M includes an optical signal input 417-1 to 417-M, respectively, that is connected to a corresponding one of optical fibers 611-1 to 611-M, respectively, to receive modulated light of various wavelengths from other devices within the optical data communication system. The optical signal inputs 417-1 to 417-M are connected to optical waveguides 409-1 to 409-M, respectively. Each of the optical waveguides 409-1 to 409-M extends past the number (N) of microring resonators 411-x-1 to 411-x-N, where x identifies the particular one of the M transmit/receive macros 205-1 to 205-M, so as to enable evanescent coupling of light between the optical waveguides 409-1 to 409-M and the corresponding set of microring resonators 411-x-1 to 411-x-N. In some embodiments, each of the microring resonators 411-x-1 to 411-x-N is operated as an optical ring detector (photodetector) tuned to a corresponding one of the N wavelengths (λ₁ to λ_{N}) of the incoming modulated light. In some embodiments, each of the microring resonators 411-x-1 to 411-x-N is controlled by the corresponding receive slice circuitry 403-x-1 to 403-x-N to function as an optical ring detector (photodetector) to detect the incoming modulated light of a particular wavelength (λ_{y}, where y is in the set of 1 to N) on the corresponding optical waveguide 409-1 to 409-M. The microring resonators 411-x-1 to 411-x-N in conjunction with the corresponding receive slice circuitry 403-x-1 to 403-x-N functions to convert the incoming modulated light signals into corresponding electrical signals in accordance with the modulation pattern of the incoming light. The resulting electrical signals are processed by receive slice circuitry 403-x-1 to 403-x-N to recreate the digital data upon which the incoming modulated light was modulated.

Various embodiments are disclosed herein for high-bandwidth, multi-wavelength WDM optical data communication systems comprising multiple photonic/electronic chips (electro-optical chips), e.g., CMOS, SOI, or other types of integrated circuit chips, that share a common remote multi-wavelength optical power supply. In some embodiments, the optical data communication system includes a single remote optical power supply that is used to deliver CW laser light to multiple electro-optical chips. In some embodiments, an optical distribution network is implemented within the remote optical power supply to deliver either all or a subset of CW laser wavelengths to each of a number of optical output ports of the optical distribution network. A subset of the optical output ports of the optical distribution network is then optically connected to a respective one of the multiple electro-optical chips. The optical connections between the remote optical power supply and the multiple electro-optical chips can be made in a various ways, such as by one or more of optical fibers, an optical interposer, free-space optical coupling, among essentially any other optical conveyance and connection technique/device.

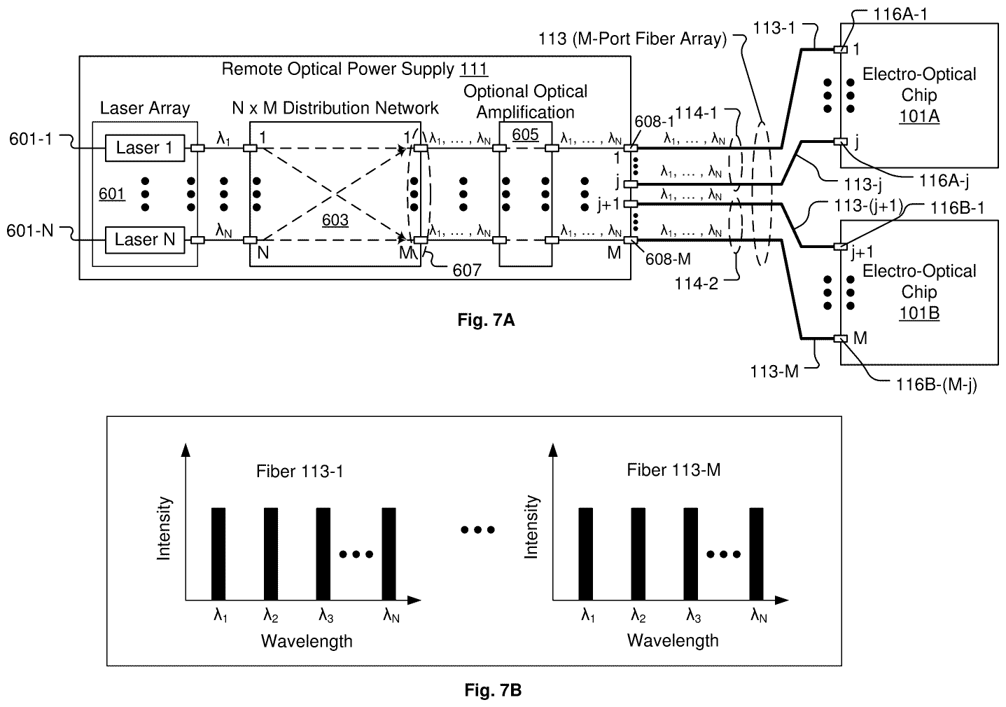

FIG. 7A shows an example optical data communication system in which the remote optical power supply 111 is optically connected to supply CW laser light to each of multiple electro-optical chips 101A, 101B, in accordance with some embodiments. The remote optical power supply 111 includes the laser array 601, the N×M optical distribution network 603, and the optional optical amplification module 605, as discussed with regard to FIG. 6A. The remote optical power supply 111 operates to provide multiple wavelengths (λ₁ to λ_{N}) of CW laser light through each of multiple optical outputs 608-1 to 608-M and in turn through each of the multiple optical fibers 113-1 to 113-M, respectively, of the M-port optical fiber array 113. In some embodiments, the M-port optical fiber array 113 is divided into multiple subgroups of optical fibers, where each subgroup of optical fibers is connected to convey CW laser light to a respective one of multiple electro-optical chips. For example, in the embodiment of FIG. 7A, the M-port optical fiber array 113 is divided into two subgroups of optical fibers, including a first subgroup of optical fibers 114-1 that includes optical fiber 113-1 through optical fiber 113-j, and a second subgroup of optical fibers 114-2 that includes optical fiber 113-(j+1) through optical fiber 113-M. The first subgroup of optical fibers (113-1 through 113-j) 114-1 is optically connected to convey CW laser light from the remote optical power supply 111 to the first electro-optical chip 101A. The second subgroup of optical fibers (113-(j+1) through 113-M) 114-2 is optically connected to convey CW laser light from the remote optical power supply 111 to the second electro-optical chip 101B.

In the embodiment of FIG. 7A, the N×M optical distribution network 603 is configured to convey each of the N different wavelengths (λ₁ to λ_{N}) of CW laser light, as respectively generated by the N lasers 601-1 to 601-N, onto each optical fiber within the first subgroup of optical fibers 114-1 (optical fibers 113-1 through 113-j), and onto each optical fiber within the second subgroup of optical fibers 114-2 (optical fibers 113-(j+1) through 113-M). In this manner, each optical supply port 116A-1 to 116A-j of the first electro-optical chip 101A is optically connected to receive each of the N different wavelengths (λ₁ to λ_{N}) of CW laser light from the remote optical power supply 111. Also, each optical supply port 116B-1 to 116B-(M−j) of the second electro-optical chip 101B is optically connected to receive each of the N different wavelengths (λ₁ to λ_{N}) of CW laser light from the remote optical power supply 111. In some embodiments, each of the optical supply ports 116A-1 to 116A-j of the first electro-optical chip 101A is optically connected to a respective transmit macro on the first electro-optical chip 101A. Similarly, in some embodiments, each of the optical supply ports 116B-1 to 116B-(M−j) of the second electro-optical chip 101B is optically connected to a respective transmit macro on the second electro-optical chip 101B.

FIG. 7B shows a diagram indicating how each of optical fiber 113-1 through optical fiber 113-j within the first subgroup of optical fibers 114-1, and each of optical fiber 113-(j+1) through optical fiber 113-M within the second subgroup of optical fibers 114-2 receives and conveys each of the multiple wavelengths (λ₁ to λ_{N}) of CW laser light from the remote optical power supply 111, in accordance with some embodiments. In some embodiments of the optical data communication system of FIG. 7A, each of the multiple wavelengths (λ₁ to λ_{N}) of CW laser light is output from the remote optical power supply 111 at a substantially equal intensity (power). However, in some embodiments of the optical data communication system of FIG. 7A, the optical power level of one or more of the multiple wavelengths (λ₁ to λ_{N}) of CW laser light as output from the remote optical power supply 111 is different than the optical power levels of others of the multiple wavelengths (λ₁ to λ_{N}) of CW laser light as output from the remote optical power supply 111.

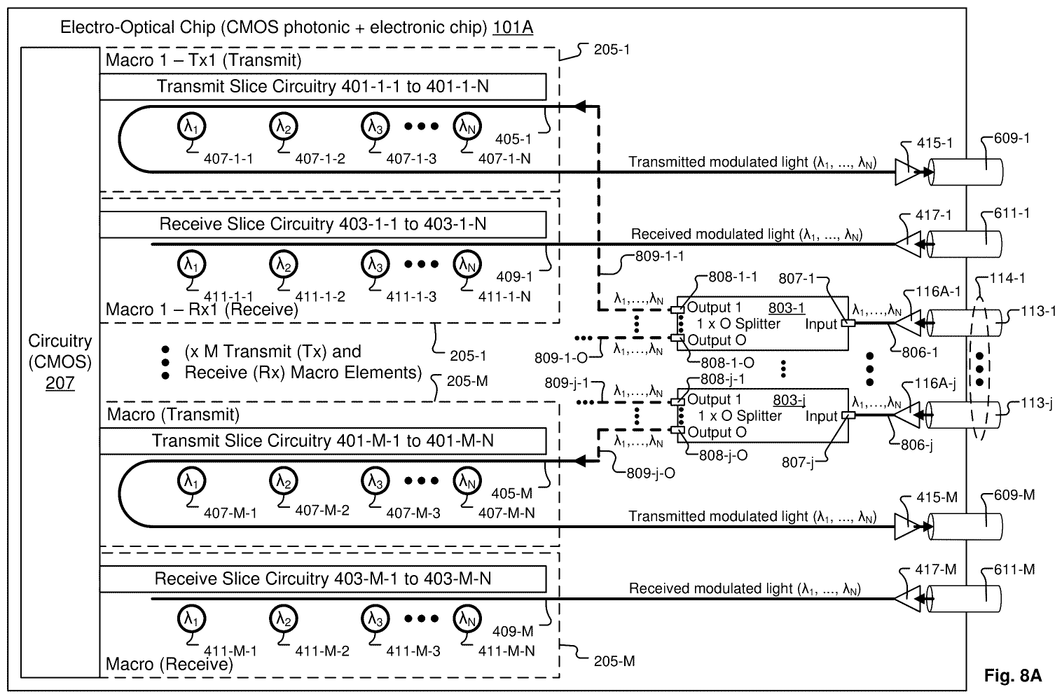

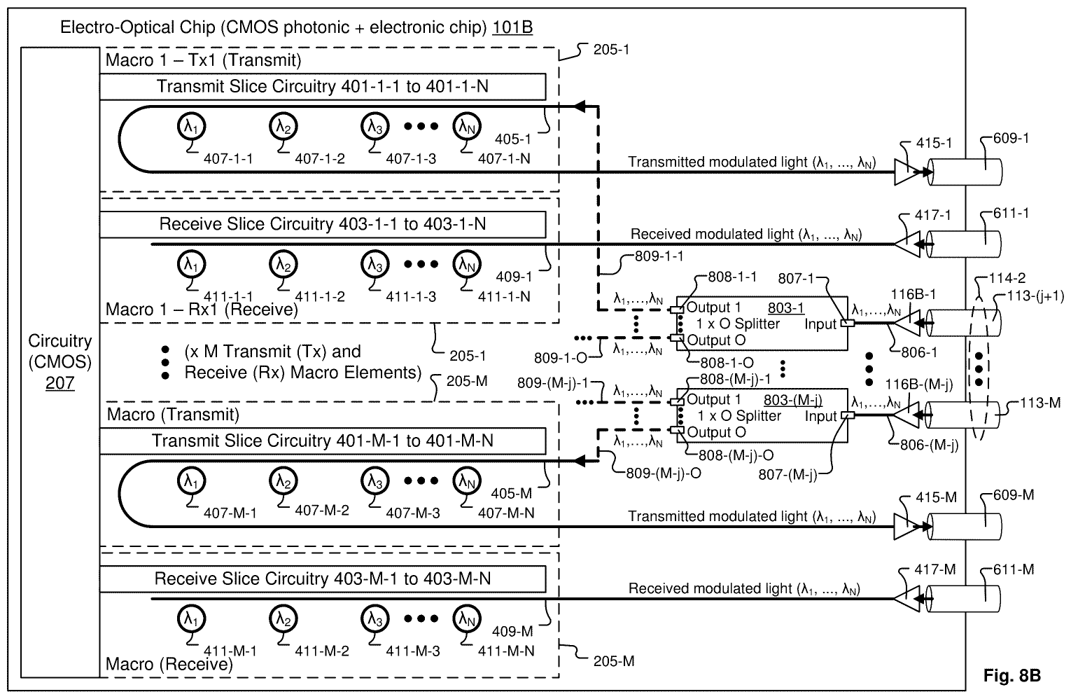

FIG. 8A shows an example diagram of the first electro-optical chip 101A of FIG. 7A is optically connected to the remote optical power supply 111 by way of optical fiber 113-1 through optical fiber 113-j of the first subgroup of optical fibers 114-1, in accordance with some embodiments. The optical fibers 113-1 to 113-j are respectively optically connected to the optical supply ports 116A-1 to 116A-j of the first electro-optical chip 101A. The first electro-optical chip 101A includes a number (j) of 1×O optical splitters 803-1 to 803-j, where (O) is an integer number greater than one. Each of the 1×O optical splitters 803-1 to 803-j has an optical input 807-1 to 807-j, respectively. The optical inputs 807-1 to 807-j are optically connected to the optical supply ports 116A-1 to 116A-j, respectively, of the first electro-optical chip 101A by way of optical waveguides 806-1 to 806-j, respectively. Each one of the 1×O optical splitters 803-x, where x is any of 1 to j, is configured to convey a portion of the light received through the corresponding optical input 807-x to each of a number of optical outputs 808-x-1 to 808-x-O of the 1×O optical splitter 803-x. In this manner, all wavelengths (λ₁ to λ_{N}) of CW laser light received through the corresponding optical input 807-x is conveyed to each of the optical outputs 808-x-1 to 808-x-O of the 1×O optical splitter 803-x. It should be understood that the 1×O optical splitter 803-x refers generally to any optical component that can split optical power received on an optical input port into multiple optical output ports. For example, 1×2 splitting can be achieved with either a 1×2 (i.e., O=2) optical splitter 803-x having one optical input port (e.g., a Y splitter or 1×2 MMI (multi-mode interferometer) splitter), or a 2×2 optical coupler having only one of two optical input ports excited (e.g., a directional coupler, adiabatic coupler, or 2×2 MMI coupler).

The electro-optical chip 101A includes the number (M) of transmit/receive macros 205-1 to 205-M. Each transmit/receive macro 205-1 to 205-M includes a transmit macro having the microring resonators 407-m-1 to 407-m-N and corresponding transmit slice circuitry 401-m-1 to 401-m-N, where m identifies the particular one of the M transmit/receive macros 205-1 to 205-M. The transmit macros of the transmit/receive macros 205-1 to 205-M include the optical waveguides 405-1 to 405-M, respectively. A given one of the optical outputs 808-x-1 to 808-x-O of a given 1×O optical splitter 803-x is optically connected to a given one of the optical waveguides 405-1 to 405-M of the transmit macros of the transmit/receive macros 205-1 to 205-M. For example, the optical output 808-1-1 of the 1×O optical splitter 803-1 is optically connected to the optical waveguide 405-1. In another example, the optical output 808-j-1 of the 1×O optical splitter 803-j is optically connected to the optical waveguide 405-M. In some embodiments, each of the optical waveguides 405-1 to 405-M is configured to extend from the transmit/receive macro 205-1 to 205-M, respectively, to one of the optical outputs 808-x-o, where x is an integer from 1 to j, and where o is an integer from 1 to O. In some embodiments, optical waveguides 809-x-o are configured to extend from the optical waveguides 405-1 to 405-M of the transmit/receive macro 205-1 to 205-M, respectively, to one of the optical outputs 808-x-o, where x is an integer from 1 to j, and where o is an integer from 1 to O. For example, in some embodiments, the optical waveguide 809-1-1 is configured to extend between the optical waveguide 405-1 of the transmit/receive macro 205-1 and the optical output 808-1-1 of the 1×O optical splitter 803-1. In another example, in some embodiments, the optical waveguide 809-j-O is configured to extend between the optical waveguide 405-M of the transmit/receive macro 205-M and the optical output 808-j-O of the 1×O optical splitter 803-j. In accordance with the foregoing, the 1×O optical splitters 803-1 to 803-j operate to convey the multiple wavelengths (λ₁ to λ_{N}) of CW light to each of the optical waveguides 405-1 to 405-M of the transmit macros of the transmit/receive macros 205-1 to 205-M.

Each of the optical waveguides 405-1 to 405-M extends past the number (N) of microring resonators 407-m-1 to 407-m-N, where m identifies the particular one of the M transmit/receive macros 205-1 to 205-M, so as to enable evanescent coupling of light between the optical waveguides 405-1 to 405-M and the corresponding set of microring resonators 407-m-1 to 407-m-N. Each of the microring resonators 407-m-1 to 407-m-N is operated as an optical ring modulator tuned to a corresponding one of the N wavelengths (λ₁ to λ_{N}) of the incoming CW laser light. Each of the microring resonators 407-m-1 to 407-m-N is controlled by the corresponding transmit slice circuitry 401-m-1 to 401-m-N to function as an optical ring modulator to modulate the incoming CW laser light of a particular wavelength (λ_{y}, where y is in the set of 1 to N) on the corresponding optical waveguide 405-1 to 405-M in accordance with electrical signals that represent digital data, so as to generate modulated light of the corresponding wavelength (λ_{y}) that has a modulation pattern that conveys the digital data represented by the electrical signals. After extending past each of the microring resonators 407-m-1 to 407-m-N, each of the optical waveguides 405-1 to 405-M extends to a respective optical signal output 415-1 to 415-M. The modulated light is transmitted from the optical signal outputs 415-1 to 415-M into respective optical fibers 609-1 to 609-M that carry the modulated light to a destination somewhere within the optical data communication system.

Additionally, in the first electro-optical chip 101A, each transmit/receive macro 205-1 to 205-M also includes the receive macro having the microring resonators 411-m-1 to 411-m-M and corresponding receive slice circuitry 403-m-1 to 403-m-N, where m identifies the particular one of the M transmit/receive macros 205-1 to 205-M. Each receive macro of the transmit/receive macros 205-1 to 205-M includes an optical signal input 417-1 to 417-M, respectively, that is connected to a corresponding one of optical fibers 611-1 to 611-M, respectively, to receive modulated light of various wavelengths from other devices within the optical data communication system. The optical signal inputs 417-1 to 417-M are connected to optical waveguides 409-1 to 409-M, respectively. Each of the optical waveguides 409-1 to 409-M extends past the number (N) of microring resonators 411-m-1 to 411-m-N, where m identifies the particular one of the M transmit/receive macros 205-1 to 205-M, so as to enable evanescent coupling of light between the optical waveguides 409-1 to 409-M and the corresponding set of microring resonators 411-m-1 to 411-m-N. In some embodiments, each of the microring resonators 411-m-1 to 411-m-N is operated as an optical ring detector (photodetector) tuned to a corresponding one of the N wavelengths (λ₁ to λ_{N}) of the incoming modulated light. In some embodiments, each of the microring resonators 411-m-1 to 411-m-N is controlled by the corresponding receive slice circuitry 403-m-1 to 403-m-N to function as an optical ring detector (photodetector) to detect the incoming modulated light of a particular wavelength (λ_{y}, where y is in the set of 1 to N) on the corresponding optical waveguide 409-1 to 409-M. The microring resonators 411-m-1 to 411-m-N in conjunction with the corresponding receive slice circuitry 403-m-1 to 403-m-N function to convert the incoming modulated light signals into corresponding electrical signals in accordance with the modulation pattern of the incoming light. The resulting electrical signals are processed by the receive slice circuitry 403-m-1 to 403-m-N to recreate the digital data upon which the incoming modulated light was modulated.

FIG. 8B shows an example diagram of the second electro-optical chip 101B of FIG. 7A optically connected to the remote optical power supply 111 by way of optical fiber 113-(j+1) through optical fiber 113-M of the second subgroup of optical fibers 114-2, in accordance with some embodiments. The optical fibers 113-(j+1) to 113-M are respectively optically connected to the optical supply ports 116B-1 to 116B-(M−j) of the second electro-optical chip 101B. The second electro-optical chip 101B includes a number (M−j) of 1×O optical splitters 803-1 to 803-(M−j), where (O) is an integer number greater than one. Each of the 1×O optical splitters 803-1 to 803-(M−j) has an optical input 807-1 to 807-(M−j), respectively. The optical inputs 807-1 to 807-(M−j) are optically connected to the optical supply ports 116B-1 to 116B-(M−j), respectively, of the second electro-optical chip 101B by way of optical waveguides 806-1 to 806-(M−j), respectively. Each one of the 1×O optical splitters 803-x, where x is any of 1 to (M−j), is configured to convey a portion of the light received through the corresponding optical input 807-x to each of a number of optical outputs 808-x-1 to 808-x-O of the 1×O optical splitter 803-x. In this manner, all wavelengths (λ₁ to λ_{N}) of CW laser light received through the corresponding optical input 807-x is conveyed to each of the optical outputs 808-x-1 to 808-x-O of the 1×O optical splitter 803-x.

The second electro-optical chip 101B includes the number (M) of transmit/receive macros 205-1 to 205-M. Each transmit/receive macro 205-1 to 205-M includes the transmit macro having the microring resonators 407-m-1 to 407-m-N and corresponding transmit slice circuitry 401-m-1 to 401-m-N, where m identifies the particular one of the M transmit/receive macros 205-1 to 205-M. The transmit macros of the transmit/receive macros 205-1 to 205-M include the optical waveguides 405-1 to 405-M, respectively. A given one of the optical outputs 808-x-1 to 808-x-O of a given 1×O optical splitter 803-x is optically connected to a given one of the optical waveguides 405-1 to 405-M of the transmit macros of the transmit/receive macros 205-1 to 205-M. For example, the optical output 808-1-1 of the 1×O optical splitter 803-1 is optically connected to the optical waveguide 405-1. In another example, the optical output 808-(M−j)-1 of the 1×O optical splitter 803-(M−j) is optically connected to the optical waveguide 405-M. In some embodiments, each of the optical waveguides 405-1 to 405-M is configured to extend from the transmit/receive macro 205-1 to 205-M, respectively, to one of the optical outputs 808-x-o, where x is an integer from 1 to j, and where o is an integer from 1 to O. In some embodiments, optical waveguides 809-x-o are configured to extend from the optical waveguides 405-1 to 405-M of the transmit/receive macro 205-1 to 205-M, respectively, to one of the optical outputs 808-x-o, where x is an integer from 1 to j, and where o is an integer from 1 to O. For example, in some embodiments, the optical waveguide 809-1-1 is configured to extend between the optical waveguide 405-1 of the transmit/receive macro 205-1 and the optical output 808-1-1 of the 1×O optical splitter 803-1. In another example, in some embodiments, the optical waveguide 809-(M−j)-O is configured to extend between the optical waveguide 405-M of the transmit/receive macro 205-M and the optical output 808-(M−j)-O of the 1×O optical splitter 803-(M−j). In accordance with the foregoing, the 1×O optical splitters 803-1 to 803-(M−j) operate to convey the multiple wavelengths (λ₁ to λ_{N}) of CW light to each of the optical waveguides 405-1 to 405-M of the transmit macros of the transmit/receive macros 205-1 to 205-M. Additionally, in the second electro-optical chip 101B, each transmit/receive macro 205-1 to 205-M also includes the receive macro having the microring resonators 411-m-1 to 411-m-M and corresponding receive slice circuitry 403-m-1 to 403-m-N, where m identifies the particular one of the M transmit/receive macros 205-1 to 205-M.

In some embodiments, each electro-optical chip 101A and 101B is configured to include a 1×O optical splitter 803-x on each optical supply port 116A-x and 116B-x, respectively, for conveyance of incoming CW light to the transmit/receive macros 205-1 to 205-M. It should be appreciated that implementation of the 1×O optical splitters 803-x allows the number M of transmit/receive macros 205-1 to 205-M to exceed the number of optical supply ports 116A-x and 116B-x of the electro-optical chips 101A and 101B, respectively. It should also be appreciated that, for a given number M of transmit/receive macros 205-1 to 205-M, implementation of the 1×O optical splitters 803-x enables optical power delivery using a reduced number of optical supply ports 116A-x and 116B-x, which can reduce the cost and complexity of the electro-optical chips 101A and 101B, respectively. For example, implementation of the 1×O optical splitters 803-x provides for optical connection of the remote optical power supply 111 to each of the electro-optical chips 101A and 101B by a reduced number of optical fibers 113-x. Also, it should be understood that in various embodiments the remote optical power supply 111 is optically connected to supply CW light to each of a number C of electro-optical chips that are configured similar to the electro-optical chips 101A and 101B, where C is greater than two. In these embodiments, the optical fiber array 113 is divided into at least the number C of subgroups of optical fibers 114-1 to 114-C for optical connection of the remote optical power supply 111 to the C electro-optical chips by way of the C subgroups of optical fibers 114-1 to 114-C, respectively.

As discussed with regard to FIGS. 7A, 7B, 8A, and 8B, various embodiments are disclosed herein for an optical data communication system in which the single multi-wavelength remote optical power supply 111 provides optical power to multiple CMOS photonic/electronic optical communication chips 101A, 101B. In these embodiments, a subset of the output ports of the remote optical power supply 111, is connected to each CMOS photonic/electronic optical communication chip 101A, 101B. Each output port of the remote optical power supply 111, can contain a subset of wavelengths or all of the wavelengths (λ₁ to λ_{N}) of CW laser light as generated by the remote optical power supply 111. In various embodiments, the output ports of the remote optical power supply 111, can be connected to the input ports of the CMOS photonic/electronic optical communication chip 101A, 101B, in a variety of ways, such as by optical fibers 113, optical interposers, free-space optical coupling, among other types of optical conveyance/connection devices and techniques.

As shown by way of example in FIGS. 7A, 7B, 8A, and 8B, embodiments are disclosed herein for an optical data communication system that includes the optical power supply 111, and the plurality of electro-optical chips 101A, 101B. The optical power supply 111 includes the plurality of lasers 601-1 to 601-N. Each of the plurality of lasers 601-1 to 601-N is configured to generate and output a beam of CW light of a different one of the plurality of wavelengths (λ₁ to λ_{N}). The optical power supply 111, has a plurality of optical outputs, e.g., 608-1 to 608-M. The optical power supply 111 is configured to convey all of the plurality of wavelengths (λ₁ to λ_{N}) of CW light through each of the plurality of optical outputs 608-1 to 608-M. Each of the plurality of electro-optical chips 101A, 101B exists separate and remote from the optical power supply 111. Each electro-optical chip of the plurality of electro-optical chips 101A, 101B has multiple optical inputs 116A-1 to 116A-j, 116B-1 to 116B-(M−j) respectively optically connected to optical outputs within a corresponding portion of the plurality of optical outputs 608-1 to 608-M of the optical power supply 111. Each electro-optical chip of the plurality of electro-optical chips 101A, 101B is optically connected to a different portion of the plurality of optical outputs 608-1 to 608-M of the optical power supply 111.

In some embodiments, each electro-optical chip of the plurality of electro-optical chips 101A, 101B includes the plurality of transmit macros 205-1 to 205-M, where each of the plurality of transmit macros includes the respective optical waveguide 405-1 to 405-M, and the respective plurality of ring resonators 407-m-1 to 407-m-N, positioned within an evanescent optical coupling distance of the respective optical waveguide. In some embodiments, the total number M of transmit macros within the plurality of transmit macros 205-1 to 205-M of a given electro-optical chip 101A, 101B, is greater than a total number of the multiple optical inputs 116A-1 to 116A-j, 116B-1 to 116B-(M−j) of the given electro-optical chip. In some embodiments, a total number N of wavelengths of the plurality of wavelengths (λ₁ to λ_{N}) is equal to a total number of ring resonators of the respective plurality of ring resonators 407-m-1 to 407-m-N. In some embodiments, each ring resonator of the respective plurality of ring resonators 407-m-1 to 407-m-N is tuned to optically couple a different wavelength of the plurality of wavelengths (λ₁ to λ_{N}) of CW light.

In some embodiments, each electro-optical chip of the plurality of electro-optical chips 101A, 101B includes at least one optical splitter 803-x having a single optical input and multiple optical outputs. The at least one optical splitter 803-x is configured to distribute all wavelengths (λ₁ to λ_{N}) of light received through the single optical input to each of the multiple optical outputs. The single optical input of a given optical splitter 803-x within a given electro-optical chip 101A, 101B is optically connected to one of the multiple optical inputs 116A-1 to 116A-j, 116B-1 to 116B-(M−j) of the given electro-optical chip. In some embodiments, the at least one optical splitter 803-x is a plurality of optical splitters 803-1 to 803-j within at least one of the plurality of electro-optical chips 101A, 101B. In some embodiments, the total number of optical splitters 803-x within the given electro-optical chip 101A, 101B is equal to the total number of the multiple optical inputs, e.g., 116A-1 to 116A-j, 116B-1 to 116B-(M−j), of the given electro-optical chip. Also, in some embodiments, the total number of the multiple optical outputs of all of the at least one optical splitter 803-x within the given electro-optical chip 101A, 101B, is equal to the total number M of transmit macros within the plurality of transmit macros 205-1 to 205-M of the given electro-optical chip.

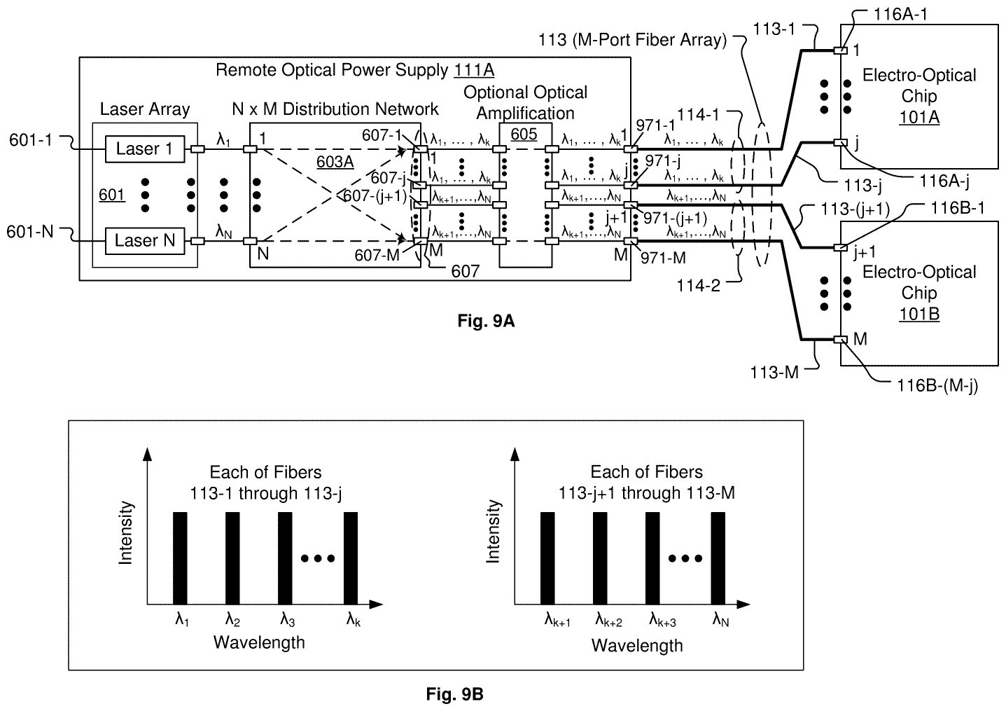

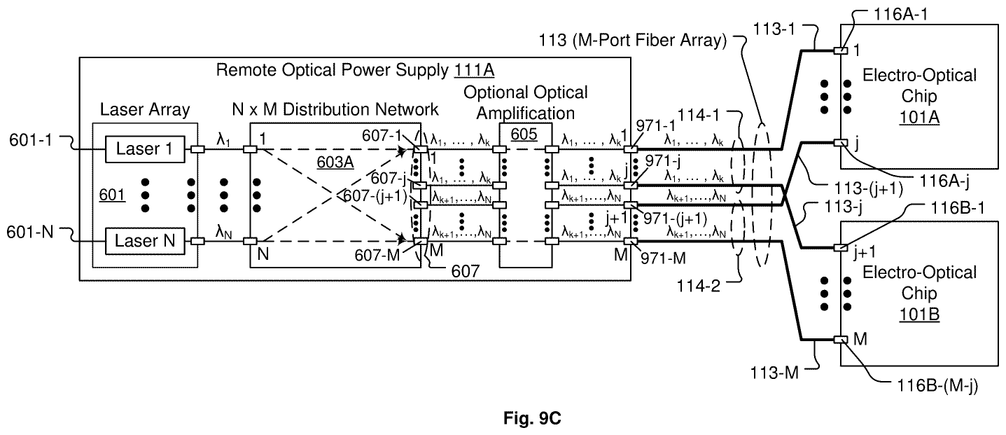

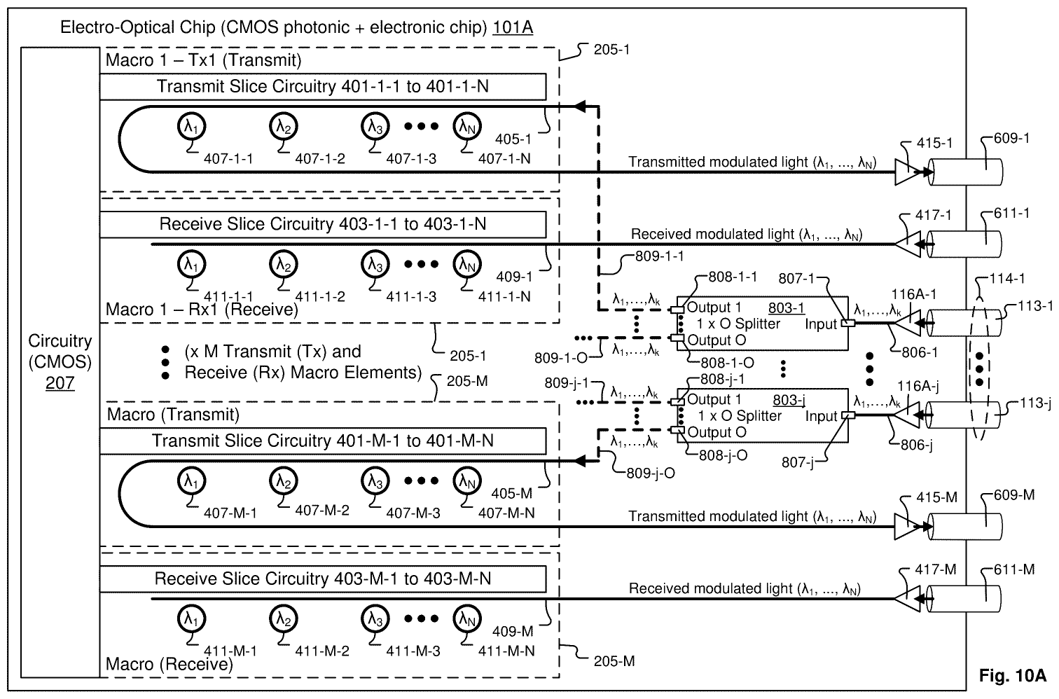

FIG. 9A shows an example optical data communication system in which a remote optical power supply 111A is optically connected to supply different wavelength groupings of CW laser light to different ones of multiple electro-optical chips 101A, 101B, in accordance with some embodiments. The remote optical power supply 111A is configured like the remote optical power supply 111 of FIG. 7A, with exception of implementing an N×M optical distribution network 603A in place of the N×M optical distribution network 603. The N×M optical distribution network 603A is configured to route different subgroups of the CW laser light wavelengths, as generated by the multiple laser elements 601-1 through 601-N, to respective subgroups of the number M of optical output ports 607 of the optical distribution network 603A. For example, the optical distribution network 603A is configured to convey a first subgroup of wavelengths (λ₁ to λₖ) of CW laser light to each optical output in a first subgroup of j optical outputs 607-1 to 607-j of the optical distribution network 603A. Also, the optical distribution network 603A is configured to convey a second subgroup of wavelengths (λₖ₊₁ to λ_{N}) of CW laser light to each optical output in a second subgroup of (M−j) optical outputs 607-(j+1) to 607-M of the optical distribution network 603A. The first subgroup of wavelengths (λ₁ to λₖ) of CW laser light are conveyed to a first subgroup of j optical outputs 971-1 to 971-j of the remote optical power supply 111A, either directly or optionally through the optical amplification module 605. The second subgroup of wavelengths (λₖ₊₁ to λ_{N}) of CW laser light are conveyed to a second subgroup of (M−j) optical outputs 971-(j+1) to 971-M of the remote optical power supply 111A, either directly or optionally through the optical amplification module 605.

The first subgroup of j optical outputs 971-1 to 971-j of the remote optical power supply 111A are respectively optically connected to the first subgroup of optical fibers (113-1 through 113-j) 114-1. The second subgroup of (M−j) optical outputs 971-(j+1) to 971-M of the remote optical power supply 111A are respectively optically connected to the second subgroup of optical fibers (113-(j+1) through 113-M) 114-2. The first subgroup of optical fibers (113-1 through 113-j) 114-1 is optically connected to convey the first subgroup of wavelengths (λ₁ to λₖ) of CW laser light from the remote optical power supply 111A to the first electro-optical chip 101A. The second subgroup of optical fibers (113-(j+1) through 113-M) 114-2 is optically connected to convey the second subgroup of wavelengths (λₖ₊₁ to λ_{N}) of CW laser light from the remote optical power supply 111A to the second electro-optical chip 101B. In this manner, each optical supply port 116A-1 to 116A-j of the first electro-optical chip 101A is optically connected to receive first subgroup of wavelengths (λ₁ to λₖ) of CW laser light from the remote optical power supply 111A. Also, each optical supply port 116B-1 to 116B-(M−j) of the second electro-optical chip 101B is optically connected to receive the second subgroup of wavelengths (λₖ₊₁ to λ_{N}) of CW laser light from the remote optical power supply 111A. It should be understood that the example optical data communication system of FIG. 9A shows how different subsets of laser channels and/or wavelengths can be directed to different electro-optical chips.

FIG. 9B shows a diagram indicating how each of optical fiber 113-1 through optical fiber 113-j within the first subgroup of optical fibers 114-1 receives and conveys each of the multiple wavelengths (λ₁ to λₖ) of CW laser light from the remote optical power supply 111A, and how each of optical fiber 113-(j+1) through optical fiber 113-M within the second subgroup of optical fibers 114-2 receives and conveys each of the multiple wavelengths (λₖ₊₁ to λ_{N}) of CW laser light from the remote optical power supply 111A, in accordance with some embodiments. In some embodiments of the optical data communication system of FIG. 9A, each of the multiple wavelengths (λ₁ to λ_{N}) of CW laser light is output from the remote optical power supply 111A at a substantially equal intensity (power). However, in some embodiments of the optical data communication system of FIG. 9A, the optical power level of one or more of the multiple wavelengths (λ₁ to λ_{N}) of CW laser light as output from the remote optical power supply 111A is different than the optical power levels of others of the multiple wavelengths (λ₁ to λ_{N}) of CW laser light as output from the remote optical power supply 111A.

FIG. 9C shows a variation of the example optical data communication system of FIG. 9A in which a given one of the multiple electro-optical chips 101A, 101B is optically connected to multiple optical fibers 113-x (where x is within the range from 1 to M) that convey different subsets of the wavelengths of CW laser light, in accordance with some embodiments. More specifically, in this embodiment, a portion of the optical outputs 971-1 to 971-j are optically connected to the first electro-optical chip 101A, and a remaining portion of the optical outputs 971-1 to 971-j are optically connected to the second electro-optical chip 101B. Also, in this embodiment, a portion of the optical outputs 971-(j+1) to 971-M are optically connected to the first electro-optical chip 101A, and a remaining portion of the optical outputs 971-(j+1) to 971-M are optically connected to the second electro-optical chip 101B. In this example embodiment, while each optical fiber 113-x does not contain all of the wavelengths of CW laser light, each of the first electro-optical chip 101A and the second electro-optical chip 101B will receive a larger number of wavelengths of CW laser light than what is carried in a single one of the optical fibers 113-1 to 113-M.

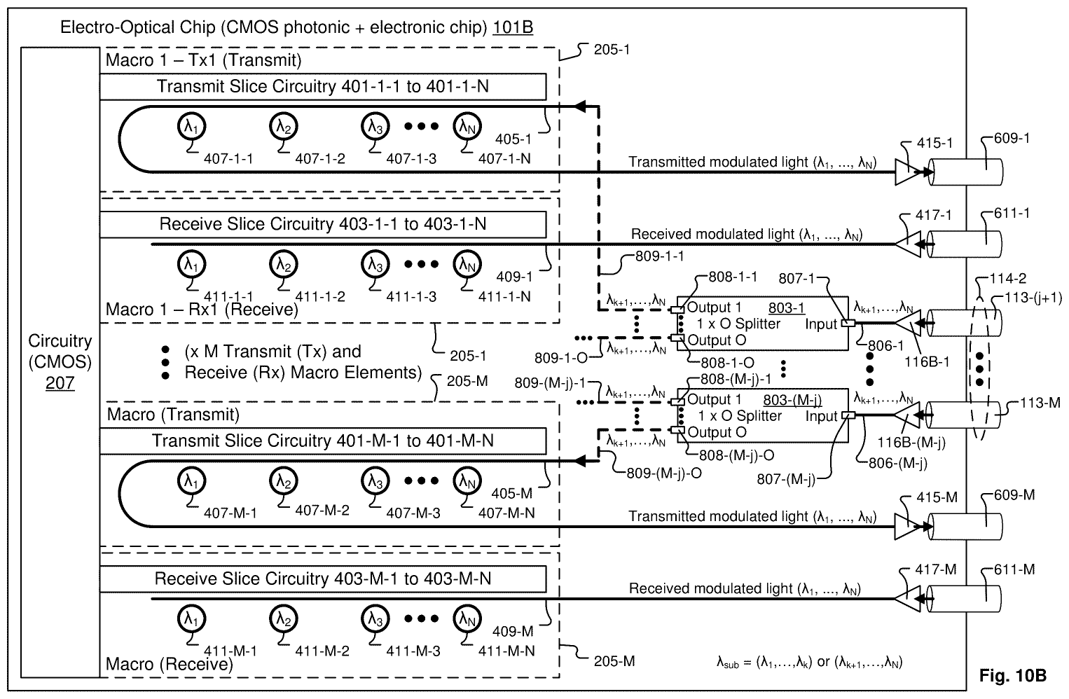

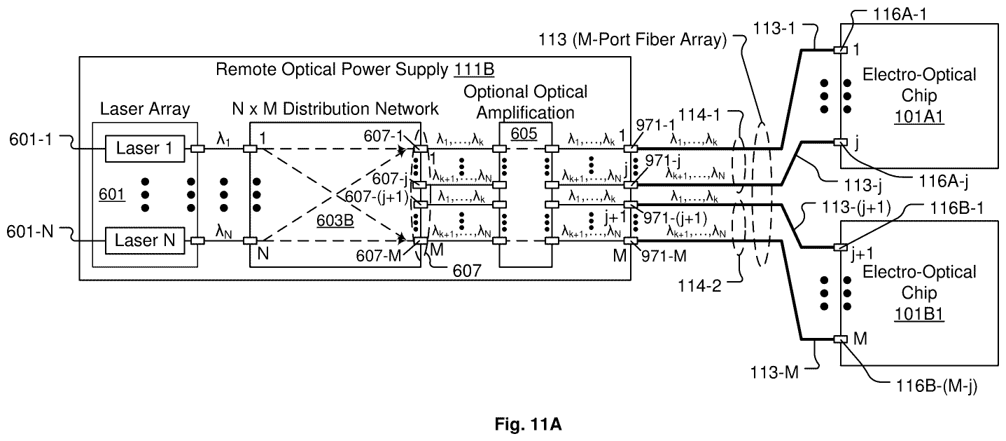

FIG. 10A shows an example diagram of the first electro-optical chip 101A of FIG. 8A optically connected to the remote optical power supply 111A of FIG. 9A by way of optical fiber 113-1 through optical fiber 113-j of the first subgroup of optical fibers 114-1, in accordance with some embodiments. The optical fibers 113-1 to 113-j are respectively optically connected to the optical supply ports 116A-1 to 116A-j of the first electro-optical chip 101A. Each of the optical fibers 113-1 to 113-j conveys the first subgroup of wavelengths (λ₁ to λₖ) of CW laser light from the remote optical power supply 111A to the electro-optical chip 101A. As discussed with regard to FIG. 8A, each one of the 1×O optical splitters 803-x, where x is any of 1 to j, is configured to convey a portion of the light received through the corresponding optical input 807-x to each of a number of optical outputs 808-x-1 to 808-x-O of the 1×O optical splitter 803-x. In this manner, all wavelengths of the first subgroup of wavelengths (λ₁ to λₖ) of CW laser light received through the corresponding optical input 807-x is conveyed to each of the optical outputs 808-x-1 to 808-x-O of the 1×O optical splitter 803-x. Then, in turn, all wavelengths of the first subgroup of wavelengths (λ₁ to λₖ) of CW laser light are conveyed to each of the optical waveguides 405-1 to 405-M of the transmit macros of the transmit/receive macros 205-1 to 205-M of the electro-optical chip 101A.

FIG. 10B shows an example diagram of the second electro-optical chip 101B of FIG. 8B optically connected to the remote optical power supply 111A of FIG. 9A by way of optical fiber 113-(j+1) through optical fiber 113-M of the second subgroup of optical fibers 114-2, in accordance with some embodiments. The optical fibers 113-(j+1) to 113-M are respectively optically connected to the optical supply ports 116B-1 to 116B-(M−j) of the second electro-optical chip 101B. Each of the optical fibers 113-(j+1) to 113-M conveys the second subgroup of wavelengths (λₖ₊₁ to λ_{N}) of CW laser light from the remote optical power supply 111A to the electro-optical chip 101B. As discussed with regard to FIG. 8B, each one of the 1×O optical splitters 803-x, where x is any of 1 to j, is configured to convey a portion of the light received through the corresponding optical input 807-x to each of a number of optical outputs 808-x-1 to 808-x-O of the 1×O optical splitter 803-x. In this manner, all wavelengths of the second subgroup of wavelengths (λₖ₊₁ to λ_{N}) of CW laser light received through the corresponding optical input 807-x is conveyed to each of the optical outputs 808-x-1 to 808-x-O of the 1×O optical splitter 803-x. Then, in turn, all wavelengths of the second subgroup of wavelengths (λₖ₊₁ to λ_{N}) of CW laser light are conveyed to each of the optical waveguides 405-1 to 405-M of the transmit macros of the transmit/receive macros 205-1 to 205-M of the electro-optical chip 111B.

As shown by way of example in FIGS. 9A, 9B, 10A, and 10B, embodiments are disclosed herein for an optical data communication system that includes the optical power supply 111A and the plurality of electro-optical chips 101A, 101B. The optical power supply 111A includes the plurality of lasers 601-1 to 601-N. Each of the plurality of lasers 601-1 to 601-N is configured to generate and output a beam of CW light of a different one of the plurality of wavelengths (λ₁ to λ_{N}). The optical power supply 111A has the plurality of optical outputs 971-1 to 971-M. The optical power supply 111A, is configured to convey a particular subset of the plurality of wavelengths (λ₁ to λ_{N}) of CW light through each optical output within a particular subset of the plurality of optical outputs 971-1 to 971-M, such that each optical output within a given subset of the plurality of optical outputs 971-1 to 971-M receives a same subset of the plurality of wavelengths (λ₁ to λ_{N}) of CW light, and such that different subsets of the plurality of optical outputs 971-1 to 971-M receive different subsets of the plurality of wavelengths (λ₁ to λ_{N}) of CW light.

Each of the plurality of electro-optical chips 101A, 101B exists separate and remote from the optical power supply 111A. Each electro-optical chip of the plurality of electro-optical chips 101A, 101B has multiple optical inputs 116A-1 to 116A-j, 116B-1 to 116B-(M−j) respectively optically connected to optical outputs within a corresponding subset of the plurality of optical outputs 971-1 to 971-M of the optical power supply 111A. Each electro-optical chip of the plurality of electro-optical chips 101A, 101B is optically connected to a different subset of the plurality of optical outputs 971-1 to 971-M of the optical power supply 111A, such that each electro-optical chip of the plurality of electro-optical chips 101A, 101B receives a different subset of the plurality of wavelengths (λ₁ to λ_{N}) of CW light from the optical power supply 111A.

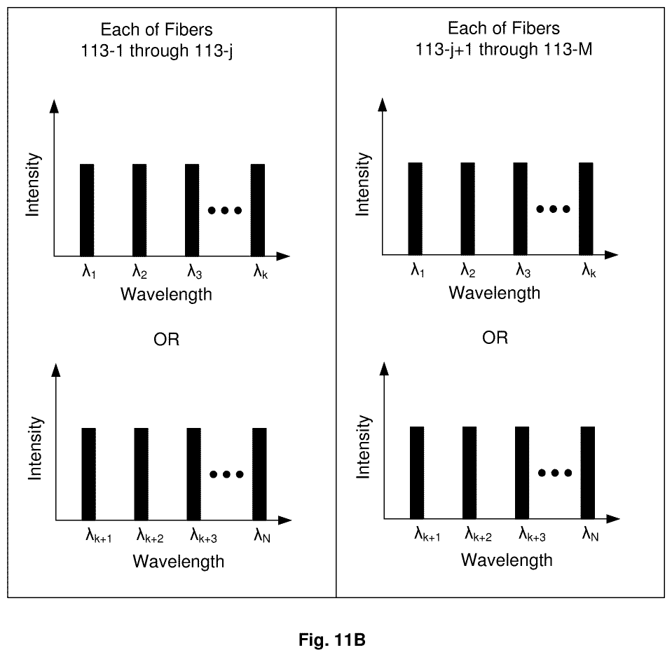

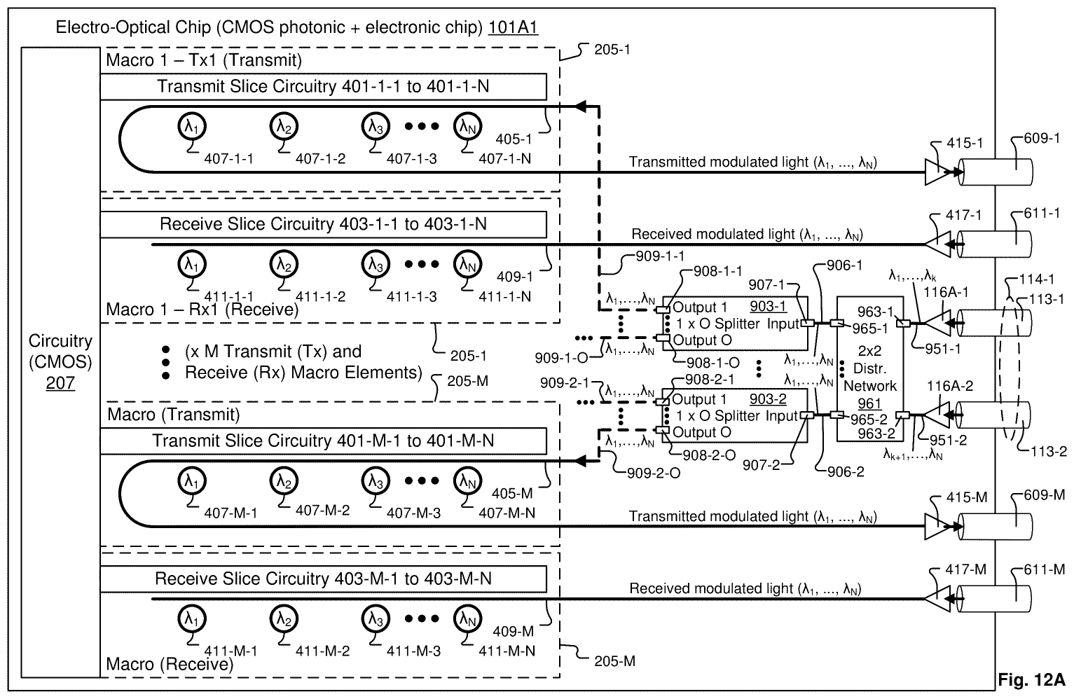

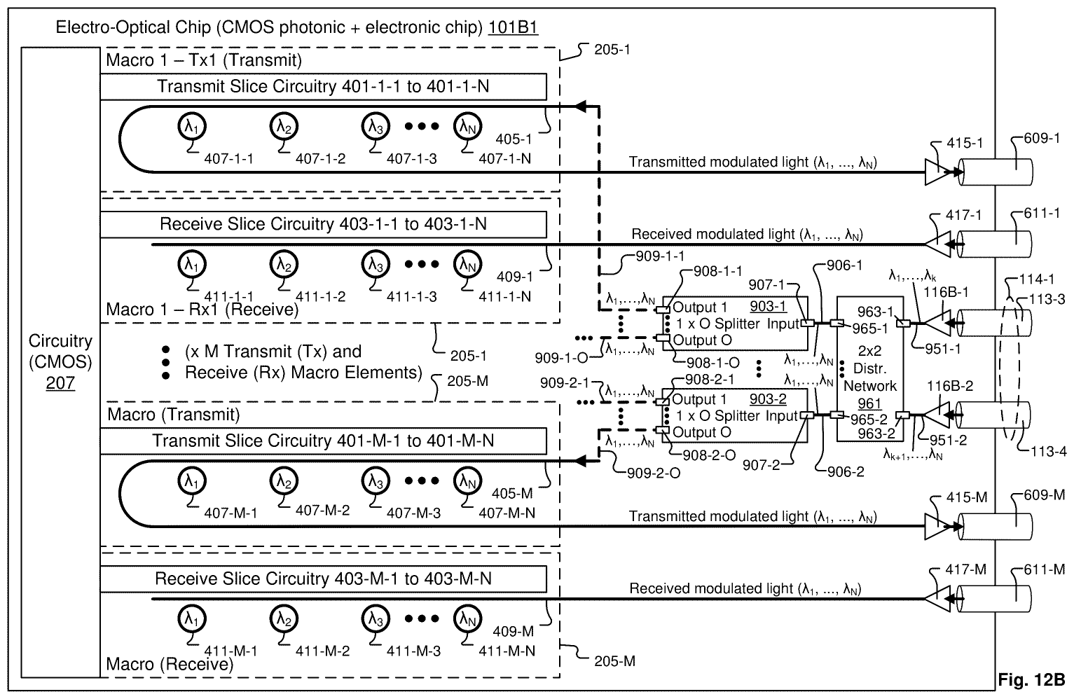

FIG. 11A shows an example optical data communication system in which a remote optical power supply 111B is optically connected to supply different wavelength groupings of CW laser light to each of multiple electro-optical chips 101A, 101B, in accordance with some embodiments. The remote optical power supply 111B is configured like the remote optical power supply 111A of FIG. 9A, with exception of implementing an N×M optical distribution network 603B in place of the N×M optical distribution network 603A. The N×M optical distribution network 603B is configured to route different subgroups of the CW laser light wavelengths, as generated by the multiple laser elements 601-1 through 601-N, to different ones of the optical output ports 607-1 to 607-M of the optical distribution network 603B, such that a given subgroup of optical outputs 607-a to 607-b of the optical distribution network 603B, where a is an integer and b is an integer greater than a, includes different optical outputs 607-z, where a≤z≤b, that convey/output different wavelength subgroupings of the CW laser light. For example, some of the first subgroup of j optical outputs 607-1 to 607-j convey the first subgroup of wavelengths (λ₁ to λₖ) of CW laser light, and some of the first subgroup of j optical outputs 607-1 to 607-j convey the second subgroup of wavelengths (λₖ₊₁ to λ_{N}) of CW laser light. Similarly, some of the second subgroup of (M−j) optical outputs 607-(j+1) to 607-M convey the first subgroup of wavelengths (λ₁ to λₖ) of CW laser light, and some of the second subgroup of (M−j) optical outputs 607-(j+1) to 607-M convey the second subgroup of wavelengths (λₖ₊₁ to λ_{N}) of CW laser light. The wavelengths of CW laser light output from each of the optical outputs 607-1 to 607-M are conveyed to a respective one of the outputs 971-1 to 971-M of the remote optical power supply 111B, either directly or through the optional optical amplification module 605.

The first subgroup of j optical outputs 971-1 to 971-j of the remote optical power supply 11lB are respectively optically connected to the first subgroup of optical fibers (113-1 through 113-j) 114-1. The second subgroup of (M−j) optical outputs 971-(j+1) to 971-M of the remote optical power supply 111B are respectively optically connected to the second subgroup of optical fibers (113-(j+1) through 113-M) 114-2. The first subgroup of optical fibers (113-1 through 113-j) 114-1 is optically connected to a first electro-optical chip 101A1. The second subgroup of optical fibers (113-(j+1) through 113-M) 114-2 is optically connected to a second electro-optical chip 101B1. In this manner, each optical supply port 116A-1 to 116A-j of the first electro-optical chip 101A1 is optically connected to receive either the first subgroup of wavelengths (λ₁ to λₖ) of CW laser light or the second subgroup of wavelengths (λₖ₊₁ to λ_{N}) of CW laser light, depending on which subgroup of wavelengths of CW laser light was conveyed into the corresponding optical fiber 113-1 to 113-j. Also, each optical supply port 116B-1 to 116B-(M−j) of the second electro-optical chip 101B1 is optically connected to receive either the first subgroup of wavelengths (λ₁ to λₖ) of CW laser light or the second subgroup of wavelengths (λₖ₊₁ to λ_{N}) of CW laser light, depending on which subgroup of wavelengths of CW laser light was conveyed into the corresponding optical fiber 113-(j+1) to 113-M.

FIG. 11B shows a diagram indicating how each of optical fiber 113-1 through optical fiber 113-j within the first subgroup of optical fibers 114-1 receives and conveys either the first subgroup of wavelengths (λ₁ to λₖ) of CW laser light or the second subgroup of wavelengths (λₖ₊₁ to λ_{N}) of CW laser light from the remote optical power supply 111B, in accordance with some embodiments. The diagram of FIG. 11B also shows how each of optical fiber 113-(j+1) through optical fiber 113-M within the second subgroup of optical fibers 114-2 receives and conveys either the first subgroup of wavelengths (λ₁ to λₖ) of CW laser light or the second subgroup of wavelengths (λₖ₊₁ to λ_{N}) of CW laser light from the remote optical power supply 111B, in accordance with some embodiments. In some embodiments of the optical data communication system of FIG. 11A, each of the multiple wavelengths (λ₁ to λ_{N}) of CW laser light is output from the remote optical power supply 111B at a substantially equal intensity (power). However, in some embodiments of the optical data communication system of FIG. 11A, the optical power level of one or more of the multiple wavelengths (λ₁ to λ_{N}) of CW laser light as output from the remote optical power supply 111B is different than the optical power levels of others of the multiple wavelengths (λ₁ to λ_{N}) of CW laser light as output from the remote optical power supply 111B.

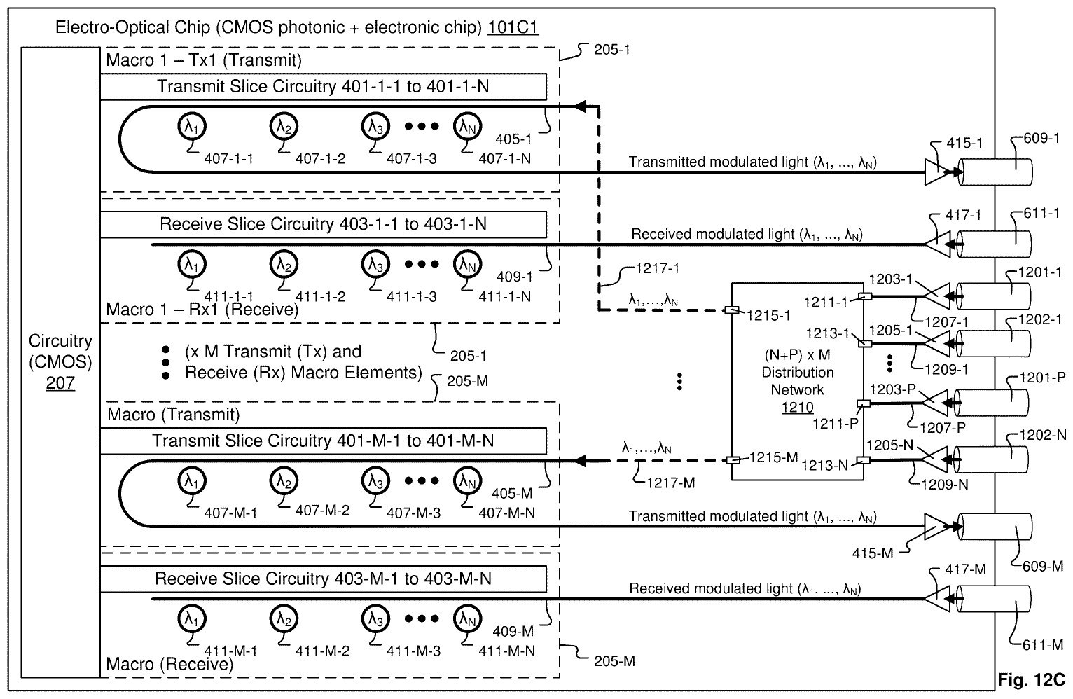

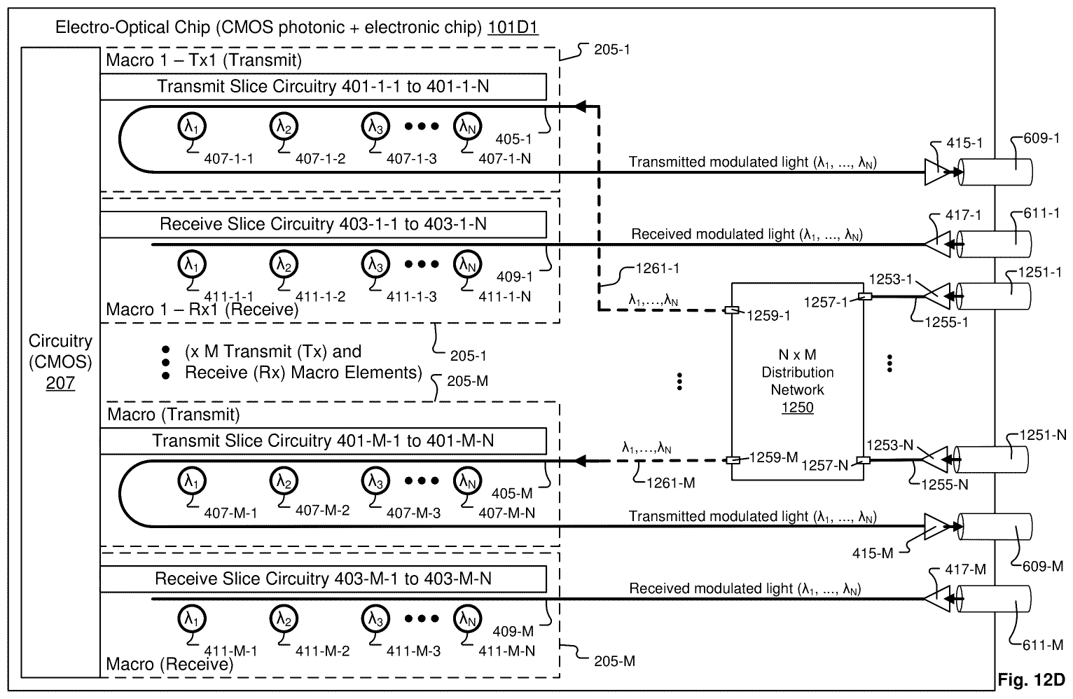

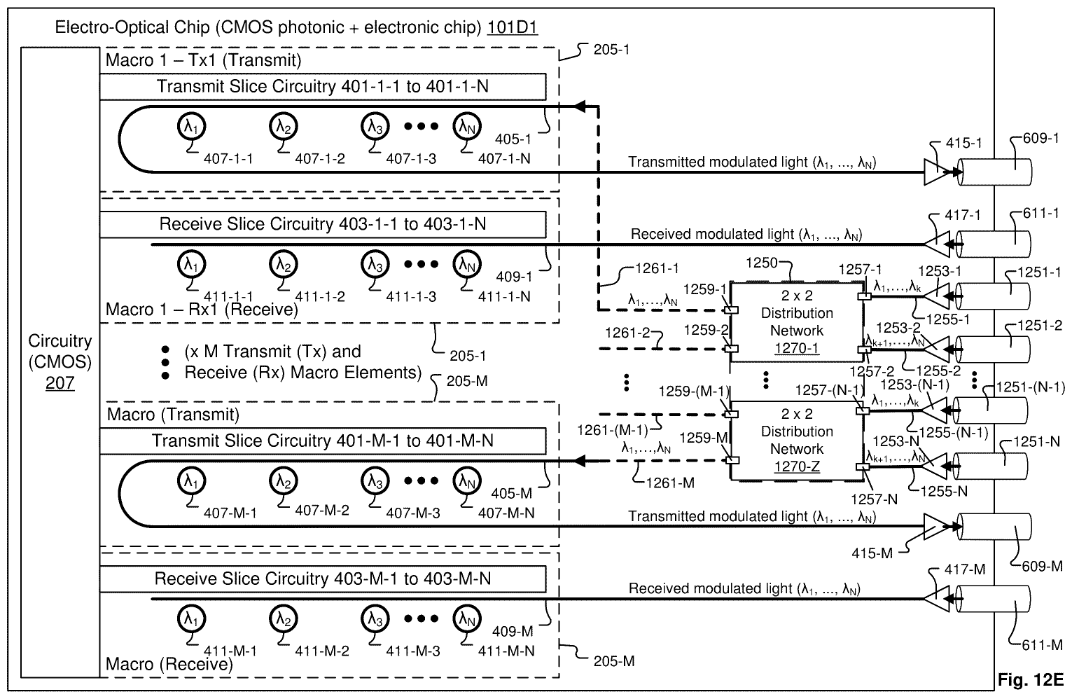

FIG. 12A shows an example diagram of the first electro-optical chip 101A1 of FIG. 11A optically connected to the remote optical power supply 111B of FIG. 11A by way of optical fiber 113-1 through optical fiber 113-j of the first subgroup of optical fibers 114-1, where j is two (2), in accordance with some embodiments. More specifically, the optical fibers 113-1 to 113-2 are respectively optically connected to the optical supply ports 116A-1 to 116A-2 of the first electro-optical chip 101A1. The optical fiber 113-1 conveys the first subgroup of wavelengths (λ₁ to λₖ) of CW laser light from the remote optical power supply 111B to the first optical supply port 116A-1 of the first electro-optical chip 101A1. The optical fiber 113-2 conveys the second subgroup of wavelengths (λₖ₊₁ to λ_{N}) of CW laser light from the remote optical power supply 111B to the second optical supply port 116A-2 of the first electro-optical chip 101A1.

The first electro-optical chip 101A1 includes a 2×2 optical distribution network 961 having a first optical input 963-1 optically connected to the first optical supply port 116A-1 by way of an optical waveguide 951-1. The 2×2 optical distribution network 961 also has a second optical input 963-2 optically connected to the second optical supply port 116A-2 by way of an optical waveguide 951-2. The 2×2 optical distribution network 961 has a first optical output 965-1 and a second optical output 965-2. The 2×2 optical distribution network 961 is configured to optically convey all of the first subgroup of wavelengths (λ₁ to λₖ) of CW laser light received through the first optical input 963-1 to each of the first optical output 965-1 and the second optical output 965-2, such that substantially equal amounts of optical power are supplied to each of the first optical output 965-1 and the second optical output 965-2. The 2×2 optical distribution network 961 is also configured to optically convey all of the second subgroup of wavelengths (λₖ₊₁ to λ_{N}) of CW laser light received through the second optical input 963-2 to each of the first optical output 965-1 and the second optical output 965-2, such that substantially equal amounts of optical power are supplied to each of the first optical output 965-1 and the second optical output 965-2. In this manner, all of the wavelengths (λ₁ to λ_{N}) of CW laser light are conveyed through each of the first optical output 965-1 and the second optical output 965-2.

The first electro-optical chip 101A1 includes two 1×O optical splitters 903-1 to 903-2, where (O) is an integer number greater than one. Each of the 1×O optical splitters 903-1 and 903-2 has an optical input 907-1 and 907-2, respectively. The optical inputs 907-1 and 907-2 are optically connected to the optical outputs 965-1 and 965-2, respectively, of the 2×2 optical distribution network 961 by way of optical waveguides 906-1 and 906-j, respectively. The 1×O optical splitter 903-1 is configured to convey a portion of the light received through the optical input 907-1 to each of a number of optical outputs 908-1-1 to 908-1-O of the 1×O optical splitter 903-1. In this manner, all wavelengths (λ₁ to λ_{N}) of CW laser light received through the optical input 907-1 are conveyed to each of the optical outputs 908-1-1 to 908-1-O of the 1×O optical splitter 903-1. Similarly, the 1×O optical splitter 903-2 is configured to convey a portion of the light received through the optical input 907-2 to each of a number of optical outputs 908-2-1 to 908-2-O of the 1×O optical splitter 903-2. In this manner, all wavelengths (λ₁ to λ_{N}) of CW laser light received through the optical input 907-2 are conveyed to each of the optical outputs 908-2-1 to 908-2-O of the 1×O optical splitter 903-2. Each of the 1×O optical splitters 903-1 and 903-2 refers generally to any optical component that can split optical power received on an optical input port into multiple optical output ports. For example, 1×2 splitting can be achieved with either the 1×2 optical splitter 903-1 and/or 903-2 having one optical input port (e.g., a Y splitter or 1×2 MMI splitter), or a 2×2 optical coupler having only one of two optical input ports excited (e.g., a directional coupler, adiabatic coupler, or 2×2 MMI coupler).

The first electro-optical chip 101A1 is configured to convey the CW light output by each one of the optical outputs 908-1-1 through 908-1-O of the first 1×O optical splitter 903-1 to a respective one of the transmit macros of the transmit/receive macros 205-1 to 205-M. In some embodiments, the first electro-optical chip 101A1 includes optical waveguides 909-1-1 through 909-1-O optically connected to optical waveguides 405-1 through 405-O, respectively, of the transmit/receive macros 205-1 to 205-M. In some embodiments, the optical waveguides 405-1 through 405-O are contiguously formed with the optical waveguides 909-1-1 through 909-1-O, respectively. In this manner, each of the optical waveguides 909-1-1 through 909-1-O conveys all wavelengths (λ₁ to λ_{N}) of CW laser light from a respective one of the optical outputs 908-1-1 to 908-1-O of the 1×O optical splitter 903-1 to a respective one of the optical waveguides 405-1 through 405-O of the transmit/receive macros 205-1 to 205-O.

The first electro-optical chip 101A1 is also configured to convey the CW light output by each one of the optical outputs 908-2-1 through 908-2-O of the second 1×O optical splitter 903-2 to a respective one of the transmit macros of the transmit/receive macros 205-1 to 205-M. In some embodiments, the first electro-optical chip 101A1 includes optical waveguides 909-2-1 through 909-2-O optically connected to optical waveguides 405-(O+1) through 405-M, respectively, of the transmit/receive macros 205-1 to 205-M. In some embodiments, the optical waveguides 405-(O+1) through 405-M are contiguously formed with the optical waveguides 909-2-1 through 909-2-O, respectively. In this manner, each of the optical waveguides 909-2-1 through 909-2-O conveys all wavelengths (λ₁ to λ_{N}) of CW laser light from a respective one of the optical outputs 908-2-1 to 908-2-O of the 1×O optical splitter 903-2 to a respective one of the optical waveguides 405-(O+1) through 405-M of the transmit/receive macros 205-(O+1) to 205-M. It should be understood that the transmit/receive macros 205-1 to 205-M of the first electro-optical chip 101A1 are configured in the same manner as described with regard to the electro-optical chip 101 of FIG. 6C.

FIG. 12B shows an example diagram of the second electro-optical chip 101B1 of FIG. 11A optically connected to the remote optical power supply 111B of FIG. 11A by way of optical fiber 113-(j+1) through optical fiber 113-M of the second subgroup of optical fibers 114-2, where j is two (2) and M is four (4), in accordance with some embodiments. More specifically, the optical fibers 113-3 and 113-4 are respectively optically connected to the optical supply ports 116B-1 and 116B-2 of the second electro-optical chip 101B1. The optical fiber 113-3 conveys the first subgroup of wavelengths (λ₁ to λₖ) of CW laser light from the remote optical power supply 111B to the first optical supply port 116B-1 of the second electro-optical chip 101B1. The optical fiber 113-4 conveys the second subgroup of wavelengths (λₖ₊₁ to λ_{N}) of CW laser light from the remote optical power supply 111B to the second optical supply port 116B-2 of the second electro-optical chip 101B1. The configuration of the second electro-optical chip 101B1 is the same as the configuration of the first electro-optical chip 101A1. Therefore, in the second electro-optical chip 101B1, the combination of the 2×2 optical distribution network 961 and the 1×O optical splitters 903-1 and 903-2 operate to convey all of the wavelengths (λ₁ to λ_{N}) of incoming CW laser light to each of the optical waveguides 405-1 through 405-M of the transmit/receive macros 205-1 to 205-M.

As shown by the first electro-optical chip 101A1 of FIG. 12A and the second electro-optical chip 101B1 of FIG. 12B, in some embodiments each input port 116A-x, 116B-x may not receive the same set of incoming wavelengths of CW light. In various embodiments, various optical distributions networks, e.g., 961, and various optical couplers and/or splitters, e.g., 903-x, are implemented to distribute all wavelengths (λ₁ to λ_{N}) of incoming CW light to all of the transmit macros of the transmit/receive macros, e.g., 205-1 to 205-M. It should be understood that in various embodiments the optical distribution networks implemented within the electro-optical chip 101A1, 101B1 can be configured and scaled to accommodate any number input optical ports 116A-x, 116B-x within the electro-optical chip. Also, it should be understood that in various embodiments, more than two subgroups of wavelengths of CW light can be conveyed from the remote optical power supply 111B to a given electro-optical chip 101A1, 101B1 through a corresponding number of optical fibers, e.g., 113-x. In these embodiments, each of the more than two subgroups of wavelengths of CW light is received at a respective input optical port 116A-x, 116B-x of the electro-optical chip. Also, in these embodiments, the electro-optical chip includes the optical distribution network 961 having a number of optical inputs 963-x that respectively correspond to the number of input optical ports 116A-x, 116B-x of the electro-optical chip 101A1, 101B1. Also, it should be understood that in various embodiments, the electro-optical chip 101A1, 101B1 can implement one or more of the 1×O optical splitters 903-x to provide for distribution of all wavelengths (λ₁ to λ_{N}) of incoming CW light to all of the transmit macros of the transmit/receive macros 205-1 to 205-M.

In some embodiments, where optical splitting is employed, optical couplers with multiple input ports are used as the splitting elements within the electro-optic chip 101A1/101B1, such as in place of the 1×O optical splitters 903-1 and 903-2 and/or the optical distribution network 961. For example, in some embodiments, a 2×2 optical coupler is implemented as the splitting element to deliver some fraction of the input optical power to each output port of the 2×2 optical coupler when input light is received at either input port of the 2×2 optical coupler. In these embodiments, one or more unused input ports of the 2×2 optical coupler is connected to one or more input optical ports 116A-x, 116B-x of the electro-optical chip 101A1/101B1. During operation, the one or more unused input ports of the optical coupler is optically excited/activated in the event of any functional failure in the optical path connected to the originally chosen input port of the optical coupler.

FIG. 12C shows an example diagram of an electro-optical chip 101C1 that implements an (N+P)×M distribution network 1210 to distribute light to the plurality of transmit macros 205-1 to 205-M, and to provide a number P of spare optical input ports 1203-1 to 1203-P, in accordance with some embodiments. The electro-optical chip 101C1 is a modification of the electro-optical chip 101A1 of FIG. 12A. The electro-optical chip 101C1 includes a number N of regular optical input ports 1205-1 to 1205-N and the number P of spare optical input ports 1203-1 to 1203-P. In the example of FIG. 12C, P equals N. However, in various embodiments, P is either less than or greater than N. The N regular optical input ports 1205-1 to 1205-N are respectively optically connected to optical fibers 1202-1 to 1202-N, each of which conveys light from the remote optical power supply 111/111A/111B. The P spare optical input ports 1203-1 to 1203-P are respectively optically connected to optical fibers 1201-1 to 1201-P, each of which is optically connected to the remote optical power supply 111/111A/111B. In general, light is not conveyed through the optical fibers 1201-1 to 1201-P and corresponding spare optical input ports 1203-1 to 1203-P at startup of the electro-optical chip 101A1. However, during operation of the electro-optical chip 101C1, when needed, any one or more of the optical fibers 1201-1 to 1201-P is usable to convey one or more wavelengths of CW light into electro-optical chip 101C1 by way of the corresponding spare optical input ports 1203-1 to 1203-P.

Each of the N of regular optical input ports 1205-1 to 1205-N is optically connected to a corresponding optical input 1213-1 to 1213-N of the (N+P)×M distribution network 1210 through a corresponding waveguide 1209-1 to 1209-N. Also, each of the P of spare optical input ports 1203-1 to 1203-P is optically connected to a corresponding optical input 1211-1 to 1211-P of the (N+P)×M distribution network 1210 through a corresponding waveguide 1207-1 to 1207-P. The (N+P)×M distribution network 1210 includes M optical outputs 1215-1 to 1215-M respectively optically connected to the plurality of transmit macros 205-1 to 205-M through respective optical waveguides 1217-1 to 1217-M. In some embodiments, the (N+P)×M distribution network 1210 is configured to convey a portion of the light received at each of the N regular optical input ports 1205-1 to 1205-N and each of the P spare optical input ports 1203-1 to 1203-P to each of the M optical outputs 1215-1 to 1215-M. In this manner, all of N wavelengths of CW light received across the N regular optical input ports 1205-1 to 1205-N and across the P spare optical input ports 1203-1 to 1203-P, when activated, are conveyed to each of the M optical outputs 1215-1 to 1215-M, and correspondingly to each of the plurality of transmit macros 205-1 to 205-M.

The electro-optical chip 101C1 is an example of a CMOS optical communication chip that incorporates the (N+P)×M distribution network 1210 to deliver light to the plurality of transmit macros 205-1 to 205-M, where the (N+P)×M distribution network 1210 has spare input ports 1211-1 to 1211-P that are not initially optically active, but that may be activated in case of a failure at any one or more of the originally active N regular optical input ports 1205-1 to 1205-N. In some embodiments, the spare input ports 1211-1 to 1211-P are optically connected to receive the same wavelength(s) of light as received at the corresponding regular optical input ports 1205-1 to 1205-N. However, in some embodiments, the spare input ports 1211-1 to 1211-P are optically connected to receive one or more wavelength(s) of light that is/are different than the wavelength(s) of light received at the corresponding regular optical input ports 1205-1 to 1205-N.

FIG. 12D shows an example diagram of an electro-optical chip 101D1 that implements an N×M distribution network 1250 to distribute light to the plurality of transmit macros 205-1 to 205-M, in accordance with some embodiments. The electro-optical chip 101D1 is a modification of the electro-optical chip 101A1 of FIG. 12A. The electro-optical chip 101D1 includes a number N of optical input ports 1253-1 to 1253-N. The N optical input ports 1253-1 to 1253-N are respectively optically connected to optical fibers 1251-1 to 1251-N, each of which conveys light from the remote optical power supply 111/111A/111B. Each of the N optical input ports 1205-1 to 1205-N is optically connected to a corresponding optical input 1257-1 to 1257-N of the N×M distribution network 1250 through a corresponding waveguide 1255-1 to 1255-N. The N×M distribution network 1250 includes M optical outputs 1259-1 to 1259-M respectively optically connected to the plurality of transmit macros 205-1 to 205-M through respective optical waveguides 1261-1 to 1261-M. In some embodiments, the N×M distribution network 1250 is configured to convey a portion of the light received at each of the N optical input ports 1257-1 to 1257-N to each of the M optical outputs 1259-1 to 1259-M. In this manner, all of N wavelengths of CW light received across the N optical input ports 1257-1 to 1257-N are conveyed to each of the M optical outputs 1259-1 to 1259-M, and correspondingly to each of the plurality of transmit macros 205-1 to 205-M.

The electro-optical chip 101D1 is an example of a CMOS optical communication chip that incorporates the N×M distribution network 1250 to deliver light to the plurality of transmit macros 205-1 to 205-M. In some embodiments, at least two of the N optical input ports 1257-1 to 1257-N of the N×M distribution network 1250 receive light of different sets of wavelengths. In some embodiments, each wavelength of light received at any of the N optical input ports 1257-1 to 1257-N of the N×M distribution network 1250 are aggregated together and distributed to each of the M optical outputs 1259-1 to 1259-M of the N×M distribution network 1250. For example, consider that wavelengths w1, w2, and w3 of light are received at optical input port 1257-1, and that wavelengths w3 and w4 of light are received at optical input port 1257-2, where N=2. In this example, the wavelengths w1, w2, w3, and w4 of light received at the input ports 1257-1 and/or 1257-2 are aggregated together and distributed to each of the output ports 1259-1 to 1259-M, such that each of the output ports 1259-1 to 1259-M receives each of the wavelengths w1, w2, w3, and w4 of light. In some embodiments, the N×M distribution network 1250 is configured to distribute light of a given wavelength substantially equally to each of the output ports 1259-1 to 1259-M, such that the given wavelength of light is delivered at substantially equal optical power to each of the output ports 1259-1 to 1259-M.

FIG. 12E shows an example diagram of the electro-optical chip 101D1 that implements the N×M distribution network 1250 as a number Z of 2×2 distribution networks 1270-1 to 1207-Z to distribute light to the plurality of transmit macros 205-1 to 205-M, in accordance with some embodiments. In some embodiments, the number Z is equal to (N/2), and the number N is even. In some embodiments, the number Z is equal to [int(N/2)+1], and the number N is odd. Each of the 2×2 distribution networks 1270-1 to 1207-Z has a first optical input, e.g., 1257-1, that receives a first subset of wavelengths of light, such as (λ₁ to λₖ). Each of the 2×2 distribution networks 1270-1 to 1207-Z has a second optical input, e.g., 1257-2, that receives a second subset of wavelengths of light, such as (λₖ₊₁ to λ_{N}). Each of the 2×2 distribution networks 1270-1 to 1207-Z is configured to aggregate and distribute all of the wavelengths (λ₁ to λ_{N}) of light received as input to each of the corresponding two optical outputs, e.g., 1259-1 and 1259-2. The optical outputs of the 2×2 distribution networks 1270-1 to 1207-Z are the output ports 1259-1 to 1259-M of the N×M distribution network 1250. In this manner, the light that is output from a given optical output of the 2×2 distribution networks 1270-1 to 1207-Z is conveyed to a respective one of the plurality of transmit macros 205-1 to 205-M by way of the corresponding optical waveguide 1261-1 to 1261-M.

As shown by way of example in FIGS. 11A, 11B, 12A, and 12B, embodiments are disclosed herein for an optical data communication system that includes the optical power supply 111B and at least one electro-optical chip 101A1, 101B1. The optical power supply 111B includes the plurality of lasers 601-1 to 601-N. Each of the plurality of lasers 601-1 to 601-N is configured to generate and output a beam of CW light of a different one of the plurality of wavelengths (λ₁ to λ_{N}). The plurality of wavelengths (λ₁ to λ_{N}) is delineated into a plurality of wavelength subsets. Each one of the plurality of wavelength subsets is different and exclusive from others of the plurality of wavelength subsets. The optical power supply 111B has the plurality of optical outputs 971-1 to 971-M. The optical power supply 111B is configured to convey CW light of any one wavelength subset of the plurality of wavelength subsets through a given one of the plurality of optical outputs 971-1 to 971-M. The plurality of optical outputs 971-1 to 971-M is delineated into a plurality of subsets of optical outputs. Each one of the plurality of subsets of optical outputs is different and exclusive from others of the plurality of subsets of optical outputs. At least two optical outputs within each subset of optical outputs respectively receives different wavelength subsets of the plurality of wavelength subsets.

Each electro-optical chip 101A1, 101B1 exists separate and remote from the optical power supply 111B. Each electro-optical chip 101A1, 101B1 has multiple optical inputs 116A-x, 116B-x respectively optically connected to optical outputs 971-x within a corresponding single subset of the optical outputs 971-1 to 971-M of the optical power supply 111B. Each electro-optical chip 101A1, 101B1 includes the optical distribution network 961 configured convey all wavelengths (λ₁ to λ_{N}) of CW light collectively received through the multiple optical inputs 116A-x, 116B-x of the electro-optical chip 101A1, 101B1 through each of a number of optical outputs of the optical distribution network 961. Each electro-optical chip 101A1, 101B1 includes the optical splitter 903-x having a single optical input and multiple optical outputs, where the single optical input is optically connected to one of the optical outputs of the optical distribution network 961. The optical splitter 903-x is configured to distribute all wavelengths (λ₁ to λ_{N}) of light received through the single optical input to each of the multiple optical outputs of the optical splitter 903-x. The electro-optical chip 101A1, 101B1 is configured to convey light output from a given one of the multiple optical outputs of the optical splitter 903-x to a given optical waveguide 405-x of the plurality of transmit macros 205-1 to 205-M. Also, each optical waveguide 405-1 to 405-M of the plurality of transmit macros 205-1 to 205-M is optically connected to a different one of the multiple optical outputs of the optical splitter 903-x. In some embodiments, the total number M of transmit macros within the plurality of transmit macros 205-1 to 205-M of the electro-optical chip 101A1, 101B1 is greater than the number of optical outputs of the optical distribution network 961.

As discussed above, various embodiments are disclosed herein for an electro-optical chip, e.g., 101A, 101B, 101A1, 101B1 that has optical splitting and distribution elements connected to its optical input ports to enable optical distribution to multiple transmit/receive macros within the electro-optical chip, where the total number transmit/receive macros is greater than the number of optical input ports of the electro-optical chip. Implementation of one or more optical splitter(s) and/or one or more optical distribution network(s) within the electro-optical chip, as disclosed herein, provides for having a total number of optical inputs on the electro-optical chip (for receiving CW light) that is less than the number N of wavelengths (λ₁ to λ_{N}) of CW light received by the electro-optical chip from the remote optical power supply. Also, when optical fibers, e.g., 113-x, are used to connect the remote optical power supply to the electro-optical chip, implementation of one or more optical splitter(s) and/or one or more optical distribution network(s) within the electro-optical chip provides for a reduction in optical fiber count, which in turn provides a reduction in packaging complexity and cost. This is also advantageous in the situation where a limited number of output ports of the remote optical power supply are available to each electro-optical chip. In this situation, optical power splitting onboard the electro-optical chip is used to deliver CW light to each of the transmit/receive macros on the electro-optical chip.

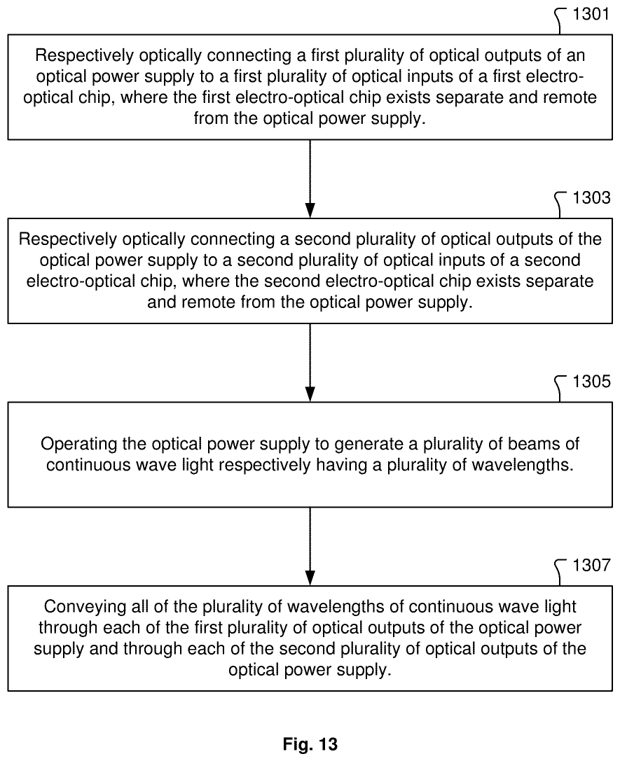

FIG. 13 shows a flowchart of a method for optical data communication, in accordance with some embodiments. The method includes an operation 1301 for respectively optically connecting a first plurality of optical outputs of an optical power supply to a first plurality of optical inputs of a first electro-optical chip, where the first electro-optical chip exists separate and remote from the optical power supply. The method also includes an operation 1303 for respectively optically connecting a second plurality of optical outputs of the optical power supply to a second plurality of optical inputs of a second electro-optical chip, where the second electro-optical chip exists separate and remote from the optical power supply. The method also includes an operation 1305 for operating the optical power supply to generate a plurality of beams of CW light respectively having a plurality of wavelengths. The method also includes an operation 1307 for conveying all of the plurality of wavelengths of CW light through each of the first plurality of optical outputs of the optical power supply and through each of the second plurality of optical outputs of the optical power supply.

The method of FIG. 13 also includes operating a first plurality of transmit macros within the first electro-optical chip, where each of the first plurality of transmit macros includes a respective optical waveguide and a respective plurality of ring resonators positioned within an evanescent optical coupling distance of the respective optical waveguide. The method of FIG. 13 also includes operating a second plurality of transmit macros within the second electro-optical chip, where each of the second plurality of transmit macros includes a respective optical waveguide and a respective plurality of ring resonators positioned within an evanescent optical coupling distance of the respective optical waveguide. In some embodiments, a total number of transmit macros within the first plurality of transmit macros of the first electro-optical chip is greater than a total number of optical inputs within the first plurality of optical inputs of the first electro-optical chip. Also, in some embodiments, a total number of transmit macros within the second plurality of transmit macros of the second electro-optical chip is greater than a total number of optical inputs within the second plurality of optical inputs of the second electro-optical chip. In some embodiments, a total number wavelengths of the plurality of wavelengths is equal to a total number of ring resonators of the respective plurality of ring resonators within a given one of the first plurality of transmit macros within the first electro-optical chip. Also, in some embodiments, the total number wavelengths of the plurality of wavelengths is equal to a total number of ring resonators of the respective plurality of ring resonators within a given one of the second plurality of transmit macros within the second electro-optical chip. In some embodiments, the method of FIG. 13 includes tuning resonant wavelengths of the plurality of ring resonators within each of the first plurality of transmit macros within the first electro-optical chip to respectively optically couple the plurality of wavelengths of CW light. Also, in some embodiments, the method of FIG. 13 includes tuning resonant wavelengths of the plurality of ring resonators within each of the second plurality of transmit macros within the second electro-optical chip to respectively optically couple the plurality of wavelengths of CW light.

In some embodiments, the method of FIG. 13 includes using one or more optical splitters within the first electro-optical chip to convey all wavelengths of light received through the first plurality of optical inputs of the first electro-optical chip to each of the first plurality of transmit macros of the first electro-optical chip. Also, in some embodiments, the method of FIG. 13 includes using one or more optical splitters within the second electro-optical chip to convey all wavelengths of light received through the second plurality of optical inputs of the second electro-optical chip to each of the second plurality of transmit macros of the second electro-optical chip. In some embodiments, each of the first electro-optical chip and the second electro-optical chip uses multiple optical splitters. In some embodiments, a total number of optical splitters used in the first electro-optical chip is equal to a total number of the first plurality of optical inputs of the first electro-optical chip. Also, in some embodiments, a total number of optical splitters used in the second electro-optical chip is equal to a total number of the second plurality of optical inputs of the second electro-optical chip.

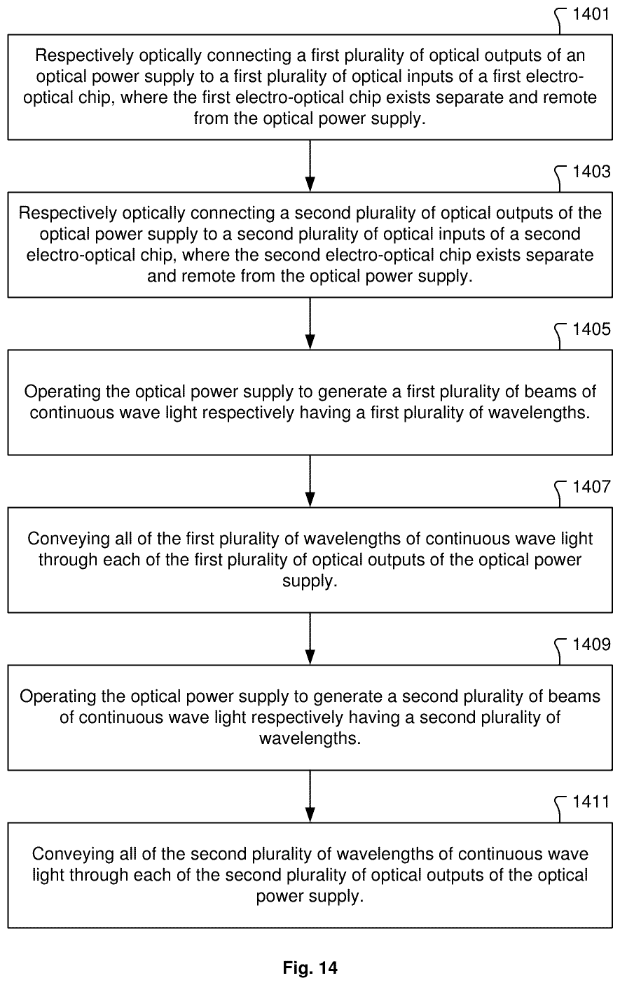

FIG. 14 shows a flowchart of a method for optical data communication, in accordance with some embodiments. The method includes an operation 1401 for respectively optically connecting a first plurality of optical outputs of an optical power supply to a first plurality of optical inputs of a first electro-optical chip, where the first electro-optical chip exists separate and remote from the optical power supply. The method also includes an operation 1403 for respectively optically connecting a second plurality of optical outputs of the optical power supply to a second plurality of optical inputs of a second electro-optical chip, where the second electro-optical chip exists separate and remote from the optical power supply. The method also includes an operation 1405 for operating the optical power supply to generate a first plurality of beams of CW light respectively having a first plurality of wavelengths. The method also includes an operation 1407 for conveying all of the first plurality of wavelengths of CW light through each of the first plurality of optical outputs of the optical power supply. The method also includes an operation 1409 for operating the optical power supply to generate a second plurality of beams of CW light respectively having a second plurality of wavelengths. The method also includes an operation 1411 for conveying all of the second plurality of wavelengths of CW light through each of the second plurality of optical outputs of the optical power supply.

In some embodiments, the method of FIG. 14 includes operating a first plurality of transmit macros within the first electro-optical chip, where each of the first plurality of transmit macros includes a respective optical waveguide and a respective plurality of ring resonators positioned within an evanescent optical coupling distance of the respective optical waveguide. Also, in some embodiments, the method of FIG. 14 includes operating a second plurality of transmit macros within the second electro-optical chip, where each of the second plurality of transmit macros includes a respective optical waveguide and a respective plurality of ring resonators positioned within an evanescent optical coupling distance of the respective optical waveguide. In some embodiments, a total number of transmit macros within the first plurality of transmit macros of the first electro-optical chip is greater than a total number of optical inputs within the first plurality of optical inputs of the first electro-optical chip. Also, in some embodiments, a total number of transmit macros within the second plurality of transmit macros of the second electro-optical chip is greater than a total number of optical inputs within the second plurality of optical inputs of the second electro-optical chip. In some embodiments, the method of FIG. 14 includes using one or more optical splitters within the first electro-optical chip to convey all wavelengths of light received through the first plurality of optical inputs of the first electro-optical chip to each of the first plurality of transmit macros of the first electro-optical chip. Also, in some embodiments, the method of FIG. 14 includes using one or more optical splitters within the second electro-optical chip to convey all wavelengths of light received through the second plurality of optical inputs of the second electro-optical chip to each of the second plurality of transmit macros of the second electro-optical chip.

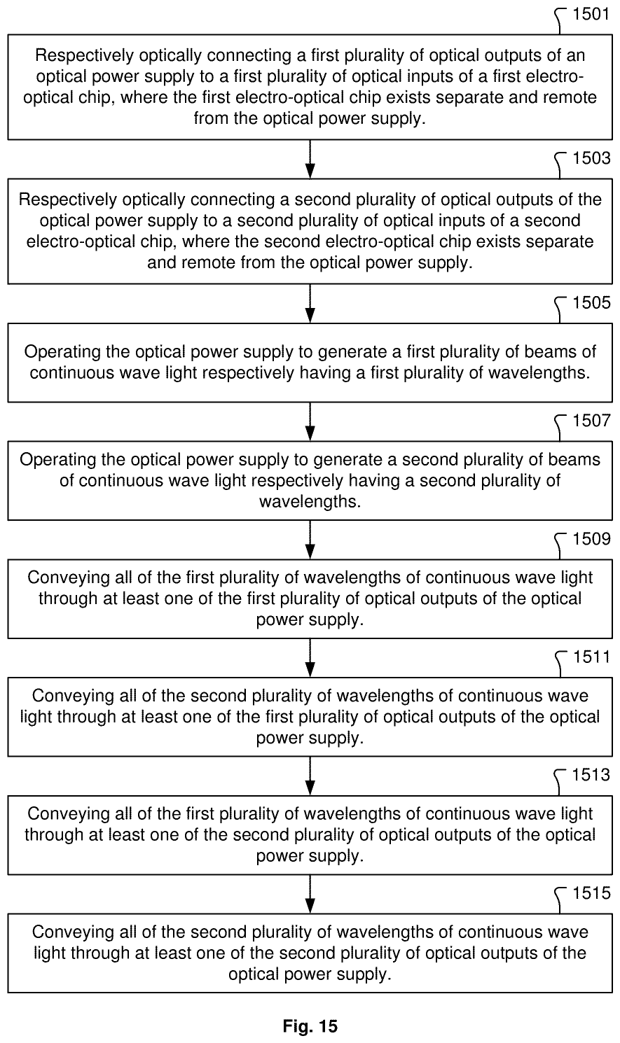

FIG. 15 shows a flowchart of a method for optical data communication, in accordance with some embodiments. The method includes an operation 1501 for respectively optically connecting a first plurality of optical outputs of an optical power supply to a first plurality of optical inputs of a first electro-optical chip, where the first electro-optical chip exists separate and remote from the optical power supply. The method also includes an operation 1503 for respectively optically connecting a second plurality of optical outputs of the optical power supply to a second plurality of optical inputs of a second electro-optical chip, where the second electro-optical chip exists separate and remote from the optical power supply. The method also includes an operation 1505 for operating the optical power supply to generate a first plurality of beams of CW light respectively having a first plurality of wavelengths. The method also includes an operation 1507 for operating the optical power supply to generate a second plurality of beams of CW light respectively having a second plurality of wavelengths. The method also includes an operation 1509 for conveying all of the first plurality of wavelengths of CW light through at least one of the first plurality of optical outputs of the optical power supply. The method also includes an operation 1511 for conveying all of the second plurality of wavelengths of CW light through at least one of the first plurality of optical outputs of the optical power supply. The method also includes an operation 1513 for conveying all of the first plurality of wavelengths of CW light through at least one of the second plurality of optical outputs of the optical power supply. The method also includes an operation 1515 for conveying all of the second plurality of wavelengths of CW light through at least one of the second plurality of optical outputs of the optical power supply.

In some embodiments, the method of FIG. 15 includes operating a first plurality of transmit macros within the first electro-optical chip, where each of the first plurality of transmit macros includes a respective optical waveguide and a respective plurality of ring resonators positioned within an evanescent optical coupling distance of the respective optical waveguide. Also, in some embodiments, the method of FIG. 15 includes operating a second plurality of transmit macros within the second electro-optical chip, where each of the second plurality of transmit macros includes a respective optical waveguide and a respective plurality of ring resonators positioned within an evanescent optical coupling distance of the respective optical waveguide. In some embodiments, a total number of transmit macros within the first plurality of transmit macros of the first electro-optical chip is greater than a total number of optical inputs within the first plurality of optical inputs of the first electro-optical chip. Also, in some embodiments, a total number of transmit macros within the second plurality of transmit macros of the second electro-optical chip is greater than a total number of optical inputs within the second plurality of optical inputs of the second electro-optical chip.

In some embodiments, the method of FIG. 15 includes using one or more optical splitters within the first electro-optical chip to convey all wavelengths of light received through the first plurality of optical inputs of the first electro-optical chip to each of the first plurality of transmit macros of the first electro-optical chip. Also, in some embodiments, the method of FIG. 15 includes using one or more optical splitters within the second electro-optical chip to convey all wavelengths of light received through the second plurality of optical inputs of the second electro-optical chip to each of the second plurality of transmit macros of the second electro-optical chip. In some embodiments, the method of FIG. 15 includes using a first optical distribution network within the first electro-optical chip to convey all wavelengths of light received through the first plurality of optical inputs of the first electro-optical chip to each of the one or more optical splitters within the first electro-optical chip. Also, in some embodiments, the method of FIG. 15 includes using a second optical distribution network within the second electro-optical chip to convey all wavelengths of light received through the second plurality of optical inputs of the second electro-optical chip to each of the one or more optical splitters within the second electro-optical chip.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. An optical data communication system, comprising:
an optical power supply including a plurality of lasers, each of the plurality of lasers configured to generate and output a beam of continuous wave light of a different one of a plurality of wavelengths, the optical power supply having a plurality of optical outputs, the optical power supply configured to convey all of the plurality of wavelengths of continuous wave light through each of the plurality of optical outputs; and
a plurality of electro-optical chips that exists separate and remote from the optical power supply, each electro-optical chip of the plurality of electro-optical chips having multiple optical inputs respectively optically connected to optical outputs within a corresponding portion of the plurality of optical outputs of the optical power supply, wherein each electro-optical chip of the plurality of electro-optical chips is optically connected to a different portion of the plurality of optical outputs of the optical power supply.

2. The optical data communication system as recited in claim 1, wherein each electro-optical chip of the plurality of electro-optical chips includes a plurality of transmit macros, each of the plurality of transmit macros including a respective optical waveguide and a respective plurality of ring resonators positioned within an evanescent optical coupling distance of the respective optical waveguide.

3. The optical data communication system as recited in claim 2, wherein a total number of transmit macros within the plurality of transmit macros of a given electro-optical chip is greater than a total number of the multiple optical inputs of the given electro-optical chip.

4. The optical data communication system as recited in claim 2, wherein a total number of wavelengths of the plurality of wavelengths is equal to a total number of ring resonators of the respective plurality of ring resonators.

5. The optical data communication system as recited in claim 4, wherein each ring resonator of the respective plurality of ring resonators is tuned to optically couple a different wavelength of the plurality of wavelengths of continuous wave light.

6. The optical data communication system as recited in claim 3, wherein each electro-optical chip of the plurality of electro-optical chips includes at least one optical splitter having at least one optical input and multiple optical outputs, the at least one optical splitter configured to distribute all wavelengths of light received through the at least one optical input to each of the multiple optical outputs, wherein each of the at least one optical input of a given optical splitter within a given electro-optical chip is optically connected to a corresponding one of the multiple optical inputs of the given electro-optical chip.

7. The optical data communication system as recited in claim 6, wherein the at least one optical splitter is a plurality of optical splitters within at least one of the plurality of electro-optical chips.

8. The optical data communication system as recited in claim 6, wherein a total number of optical splitters within the given electro-optical chip is equal to a total number of the multiple optical inputs of the given electro-optical chip, and wherein a total number of the multiple optical outputs of all of the at least one optical splitter within the given electro-optical chip is equal to the total number of transmit macros within the plurality of transmit macros of the given electro-optical chip.

9. An optical data communication system, comprising:
an optical power supply including a plurality of lasers, each of the plurality of lasers configured to generate and output a beam of continuous wave light of a different one of a plurality of wavelengths, the optical power supply having a plurality of optical outputs, the optical power supply configured to convey a particular subset of the plurality of wavelengths of continuous wave light through each optical output within a particular subset of the plurality of optical outputs, such that each optical output within a given subset of the plurality of optical outputs receives a same subset of the plurality of wavelengths of continuous wave light, and such that different subsets of the plurality of optical outputs receive different subsets of the plurality of wavelengths of continuous wave light; and
a plurality of electro-optical chips that exists separate and remote from the optical power supply, each electro-optical chip of the plurality of electro-optical chips having multiple optical inputs respectively optically connected to optical outputs within a corresponding subset of the plurality of optical outputs of the optical power supply, wherein each electro-optical chip of the plurality of electro-optical chips is optically connected to a different subset of the plurality of optical outputs of the optical power supply, such that each electro-optical chip of the plurality of electro-optical chips receives a different subset of the plurality of wavelengths of continuous wave light from the optical power supply.

10. The optical data communication system as recited in claim 9, wherein each electro-optical chip of the plurality of electro-optical chips includes a plurality of transmit macros, each of the plurality of transmit macros including a respective optical waveguide and a respective plurality of ring resonators positioned within an evanescent optical coupling distance of the respective optical waveguide.

11. The optical data communication system as recited in claim 10, wherein a total number of transmit macros within the plurality of transmit macros of a given electro-optical chip is greater than a total number of the multiple optical inputs of the given electro-optical chip.

12. The optical data communication system as recited in claim 11, wherein each electro-optical chip of the plurality of electro-optical chips includes at least one optical splitter having at least one optical input and multiple optical outputs, the at least one optical splitter configured to distribute all wavelengths of light received through the at least one optical input to each of the multiple optical outputs, wherein each of the at least one optical input of a given optical splitter within a given electro-optical chip is optically connected to a corresponding one of the multiple optical inputs of the given electro-optical chip.

13. The optical data communication system as recited in claim 12, wherein the at least one optical splitter is a plurality of optical splitters within at least one of the plurality of electro-optical chips.

14. The optical data communication system as recited in claim 12, wherein a total number of optical splitters within the given electro-optical chip is equal to a total number of the multiple optical inputs of the given electro-optical chip, and wherein a total number of the multiple optical outputs of all of the at least one optical splitter within the given electro-optical chip is equal to the total number of transmit macros within the plurality of transmit macros of the given electro-optical chip.

15. An optical data communication system, comprising:
an optical power supply including a plurality of lasers, each of the plurality of lasers configured to generate and output a beam of continuous wave light of a different one of a plurality of wavelengths, the plurality of wavelengths delineated into a plurality of wavelength subsets, each one of the plurality of wavelength subsets being different and exclusive from others of the plurality of wavelength subsets, the optical power supply having a plurality of optical outputs, the optical power supply configured to convey continuous wave light of any one wavelength subset of the plurality of wavelength subsets through a given one of the plurality of optical outputs, the plurality of optical outputs delineated into plurality of subsets of optical outputs, each one of the plurality of subsets of optical outputs being different and exclusive from others of the plurality of subsets of optical outputs, wherein at least two optical outputs within each subset of optical outputs respectively receives different wavelength subsets of the plurality of wavelength subsets;
a first electro-optical chip that exists separate and remote from the optical power supply, the first electro-optical chip having multiple optical inputs respectively optically connected to optical outputs within a first one of the plurality of subsets of optical outputs of the optical power supply; and
a second electro-optical chip that exists separate and remote from the optical power supply, the second electro-optical chip having multiple optical inputs respectively optically connected to optical outputs within a second one of the plurality of subsets of optical outputs of the optical power supply.

16. The optical data communication system as recited in claim 15, wherein each of the first electro-optical chip and the second electro-optical chip includes a corresponding plurality of transmit macros, each of the corresponding plurality of transmit macros including a respective optical waveguide and a respective plurality of ring resonators positioned within an evanescent optical coupling distance of the respective optical waveguide.

17. The optical data communication system as recited in claim 16, wherein each of the first electro-optical chip and the second electro-optical chip includes a corresponding optical distribution network configured convey all wavelengths of continuous wave light collectively received through the multiple optical inputs of said electro-optical chip through each of a number of optical outputs of the optical distribution network, wherein said electro-optical chip includes an optical splitter having at least one optical input and multiple optical outputs, wherein each of the at least one optical input is optically connected to a corresponding one of the optical outputs of the optical distribution network, the optical splitter configured to distribute all wavelengths of light received through the at least one optical input to each of the multiple optical outputs of the optical splitter.

18. The optical data communication system as recited in claim 17, wherein said electro-optical chip is configured to convey light output from a given one of the multiple optical outputs of the optical splitter to a given optical waveguide of the plurality of transmit macros.

19. The optical data communication system as recited in claim 18, wherein each optical waveguide of the plurality of transmit macros is optically connected to a different one of the multiple optical outputs of the optical splitter.

20. The optical data communication system as recited in claim 19, wherein a total number of transmit macros within the plurality of transmit macros of said electro-optical chip is greater than the number of optical outputs of the optical distribution network.

21. The optical data communication system as recited in claim 16, wherein each of the first electro-optical chip and the second electro-optical chip includes a corresponding optical distribution network configured convey all wavelengths of continuous wave light collectively received through the multiple optical inputs of said electro-optical chip through each of a number of optical outputs of the optical distribution network, wherein the number of optical outputs of the optical distribution network is equal to a number of the plurality of transmit macros within said electro-optical chip.

22. An electro-optical chip, comprising:
a plurality of transmit macros, each of the plurality of transmit macros including a respective optical waveguide and a respective plurality of ring resonators positioned within an evanescent optical coupling distance of the respective optical waveguide; and
an optical distribution network having a number of initially active optical inputs and a number of spare optical inputs, each of the number of initially active optical inputs optically connected to a respective optical fiber through which continuous wave laser light is conveyed, each of the number of spare optical inputs optically connected to a respective optical fiber through which continuous wave laser light is conveyed, wherein each of the number of spare optical inputs is activatable upon failure of a corresponding one of the initially active optical inputs, the optical distribution network having a number of optical outputs, each of the number of optical outputs is optically connected to the optical waveguide of a corresponding one of the plurality of transmit macros, wherein a total number of the plurality of transmit macros exceeds the number of initially active optical inputs.

23. An electro-optical chip as recited in claim 22, wherein the optical distribution network includes a number of optical splitting elements, each of the optical splitting elements having a first optical input optically connected to one of the initially active optical inputs, each of the optical splitting elements having a second optical input optically connected to one of the spare optical inputs, each of the optical splitting elements having multiple optical outputs respectively corresponding to multiple ones of the number of optical outputs of the optical distribution network.

24. An electro-optical chip as recited in claim 23, wherein each of the optical splitting elements is controllable to activate one or more of the first optical input and the second optical input at a given time.
